(19) United States
(12) Patent Application Publication
(10) Pub. No.: US 2022/0176602 A1
(43) Pub. Date: Jun. 9, 2022

(54) METHOD OF MANUFACTURING COMPOSITE MEMBER, AND MOLD USED THEREIN

(71) Applicant: INOAC CORPORATION, Nagoya-shi, Aichi (JP)

(72) Inventors: Ken TANAKA, Anjo-shi, Aichi (JP); Shinichi HONZAWA, Anjo-shi, Aichi (JP); Takashi YAMAGUCHI, Anjo-shi, Aichi (JP)

(21) Appl. No.: 17/603,340

(22) PCT Filed: Apr. 17, 2020
(86) PCT No.: PCT/JP2020/016939

§ 371 Date: Oct. 13, 2021

(30) Foreign Application Priority Data
Apr. 20, 2019 (JP) 2019-080574
Jul. 26, 2019 (JP) 2019-138023

(51) Int. Cl. B29C 45/14; B29C 45/26

(52) U.S. Cl. CPC B29C 45/14073; B29C 45/14795; B29L 2031/3008; B29C 45/2606; B29C 45/14786

(57) ABSTRACT

A porous plate member is positioned in one mold using a movable pin in a state in which a leading end portion including an oblique face portion provided in the one mold is projecting out toward another mold. The one mold and the other mold are clamped together to press the porous plate member, and the movable pin is pressed and retracted by the other mold. A synthetic resin material is injected into the cavity, and the flow thereof is applied to the leading end portion (42) of the movable pin to further retract the movable pin, and the synthetic resin material is cured in a state in which the synthetic resin material has entered a space in which the movable pin has been retracted, thereby manufacturing a composite member.

### TECHNICAL FIELD

The present invention relates to a method of manufacturing a composite member, and a mold used therein.

### BACKGROUND ART

Vehicle members, such as an engine undercover and an instrument panel undercover, are provided to a vehicle, such as an automobile or the like. Attempts have been made to reduce weight by forming these vehicle members as a composite member including a porous sheet and a resin molded portion. Development has also progressed, for example, in Patent Documents 1 and 2, in an attempt to impart sound absorption performance to a vehicle member formed of a composite material in this manner.

### CITATION LIST

### Patent Literature

Patent Document 1: Japanese Patent Application Laid-Open (JP-A) No. H10-296786
Patent Document 2: Japanese Patent Application Laid-Open (JP-A) No. 2017-213727

### SUMMARY OF INVENTION

### Technical Problem

However, in the molding machine proposed in Patent Document 1, holes, which are traces of the positioning pins, are opened in the design face of the product, and so the appearance is negatively affected. Opening of the holes also degrades sound insulation performance. In the technique proposed in Patent Document 2, a post-processing step of cutting an extra length portion after molding a composite member that is longer than a dimension of a composite member to be obtained is necessary. Thus, cost is increased due to the post-processing step.

An object of the present invention is to provide a method of manufacturing a composite member in which no hole is provided in a design face, and a mold used in the method.

### Solution to Problem

In accordance with one aspect of the present disclosure, there is provided A method of manufacturing a composite member, in which a porous plate member and a resin molded portion are integrally formed using a mold, the mold including: one mold; another mold facing the one mold and forming a cavity with the one mold when the one mold and the another mold are clamped together; and plural movable pins including a base end portion that is in contact with the one mold via an elastic body, the movable pin being capable of retracting a leading end portion thereof from a state in which the leading end portion projects out from a cavity face of the one mold toward the another mold, to a position that is retracted from a cavity face of the another mold at a time of clamping, by deforming the elastic body, and the leading end portion having an oblique face portion that is inclined with respect to the cavity face of the another mold, toward which the oblique face portion faces, the method including: positioning the porous plate member in the one mold using the movable pin in a state in which the leading end portion of the movable pin projects out toward the another mold; clamping the one mold and the another mold together to press the porous plate member, and pressing a leading end portion of the movable pin by the another mold to retract the movable pin against an elastic restoring force of the elastic body; and forming the composite member, in which the porous plate member and the resin molded portion are integrally formed, by injecting a synthetic resin raw material into the cavity such that a flow of the synthetic resin raw material is applied to the leading end portion of the movable pin, the movable pin is further retracted against an elastic restoring force of the elastic body, and the synthetic resin raw material is cured in a state in which the synthetic resin raw material has entered a space in which the leading end portion of the movable pin has been retracted, thereby forming a resin molded portion

In the above manufacturing method, the porous plate member may be positioned in the one mold by supporting an outer peripheral side face of the porous plate member with the movable pin.

In the above manufacturing method, through-holes may be provided in the porous plate member, and the porous plate member may be positioned in the one mold by inserting the movable pin through the through-hole.

In the above manufacturing method, the porous plate member may be pressed in a state in which a sound absorption porous structure of the porous plate member is maintained.

In the above manufacturing method, the porous plate member may be a foam or a nonwoven fabric.

In the above manufacturing method, the composite member may include a frame portion and a crosspiece portion provided so as to cross through the frame portion, and the cavity may include a porous plate member cavity portion in which the porous plate member is disposed, a frame portion cavity portion that surrounds the porous plate member cavity portion and forms the frame portion, and a crosspiece cavity portion forming the crosspiece portion.

In the above manufacturing method, the elastic body may be a spring.

In accordance with one aspect of the present disclosure, there is provided a mold for manufacturing a composite member, in which a porous plate member and a resin molded portion are integrally formed, including: one mold; another mold facing the one mold and forming a cavity with the one mold when the one mold and the another mold are clamped together; and plural movable pins including a base end portion that is in contact with the one mold via an elastic body, the movable pin being capable of retracting a leading end portion thereof from a state in which the leading end portion projects out from a cavity face of the one mold toward the another mold to a position retracted from a cavity face of the another mold at a time of clamping, by deforming the elastic body, the leading end portion of the movable pin being formed with an oblique face portion inclined with respect to a cavity face of the another mold, toward which the oblique face portion faces, and an elasticity coefficient of the elastic body being adjusted such that the leading end portion of the movable pin is retracted from a cavity face of the another mold due to a flow of a synthetic resin material being injected into the cavity.

In the above mold, the elastic body may be a spring.

In the above mold, the one mold and the another mold may be molds that are moved horizontally relative to each other and clamped.

In the above mold, the plural movable pins may be provided at positions that support a lower edge of the porous plate member.

### Advantageous Effects of Invention

The present disclosure provides a method of manufacturing a composite member in which no hole is provided in the design face, and a mold used in the method.

### BRIEF DESCRIPTION OF DRAWINGS

FIG. 1 is a perspective view illustrating a rear face of a composite member manufactured by a manufacturing method according to a first exemplary embodiment of the present disclosure.

FIG. 2 is a perspective view illustrating only a resin molded portion, with a porous sheet removed, of the composite member illustrated in FIG. 1.

FIG. 3A is a perspective view of a porous sheet prior to being pressed and deformed.

FIG. 3B is a perspective view of a porous sheet after being pressed and deformed.

FIG. 4 is a cross-section of a mold.

FIG. 5 is a cross-section illustrating a state in which a porous sheet is set to a movable mold (one mold).

FIG. 6 is a cross-section illustrating a state in which a porous sheet is set in a movable mold (one mold).

FIG. 7 is a cross-section of a mold that has been clamped together.

FIG. 8A is a partial enlarged view of FIG. 7.

FIG. 8B is a partially enlarged view illustrating a state in which the movable pin has been retracted due to injection of a resin material from the state of FIG. 8A.

FIG. 9 is a cross-section illustrating a state in which injection molding has been completed.

FIG. 10 is a partially enlarged view illustrating a demolded composite member.

FIG. 11A is a face-on view of a leading end portion of a movable pin of a first modified example.

FIG. 11B is a rear view of the movable pin of FIG. 11A.

FIG. 11C is a face-on view of a leading end portion of a movable pin of a second modified example.

FIG. 11D is a rear view of a leading end portion of the movable pin of FIG. 11C.

FIG. 12A is a cross-section of a mold of a third modified example.

FIG. 12B is a cross-section of a mold of a third modified example.

FIG. 13A is a cross-section of a mold of a fourth modified example.

FIG. 13B is a cross-section of a mold of a fourth modified example.

FIG. 14 is a perspective view of a cooling duct of a battery manufactured by a manufacturing method of the present disclosure.

FIG. 15 is a perspective view illustrating a rear face of a composite member manufactured by a manufacturing method according to a second exemplary embodiment of the present disclosure.

FIG. 16 is a perspective view illustrating only a resin molded portion, with a porous sheet removed, of the composite member illustrated in FIG. 15.

FIG. 17A is a perspective view of a porous sheet prior to being pressed and deformed.

FIG. 17B is a perspective view of a porous sheet after being pressed and deformed.

FIG. 18 is a cross-section of a mold.

FIG. 19A is a cross-section of a mold in a state in which a porous sheet is set in a movable mold (one mold).

FIG. 19B is a partial enlarged view of FIG. 19A.

FIG. 20 is a cross-section of a mold illustrating a clamped-together state.

FIG. 21A is a partially enlarged view of FIG. 20.

FIG. 21B is a partial enlarged view illustrating a state in which the movable pin has been retracted from the state of FIG. 21A.

FIG. 22 is a cross-section of a mold illustrating a state in which a resin material has been injected and injection molding has been completed.

FIG. 23 is a cross-section of a mold during demolding.

FIG. 24 is an enlarged cross-section of the demolded product of FIG. 23.

FIG. 25A is a face-on view illustrating a leading end portion of a movable pin according to a fifth modified example.

FIG. 25B is a rear view of a leading end portion of the movable pin of FIG. 25A.

FIG. 25C is a face-on view illustrating a leading end portion of a movable pin according to a sixth modified example.

FIG. 25D is a rear view of a leading end portion of the movable pin of FIG. 25C.

FIG. 26 is a view similar to FIG. 18 of a mold according to a modified example of a second exemplary embodiment.

### DESCRIPTION OF EMBODIMENTS

Detailed explanation follows regarding a method of manufacturing a composite member according to the present disclosure, and a mold used therein.

### First Exemplary Embodiment

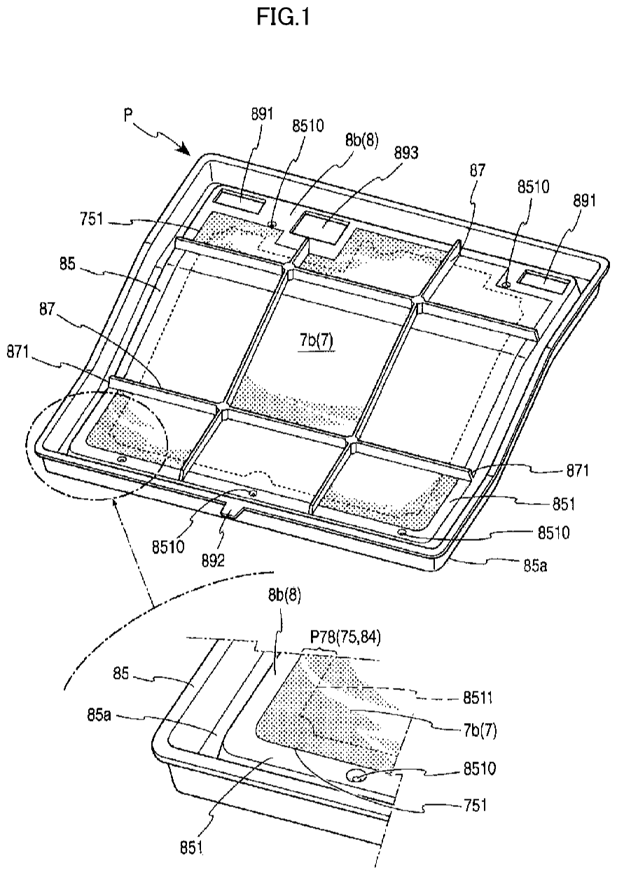

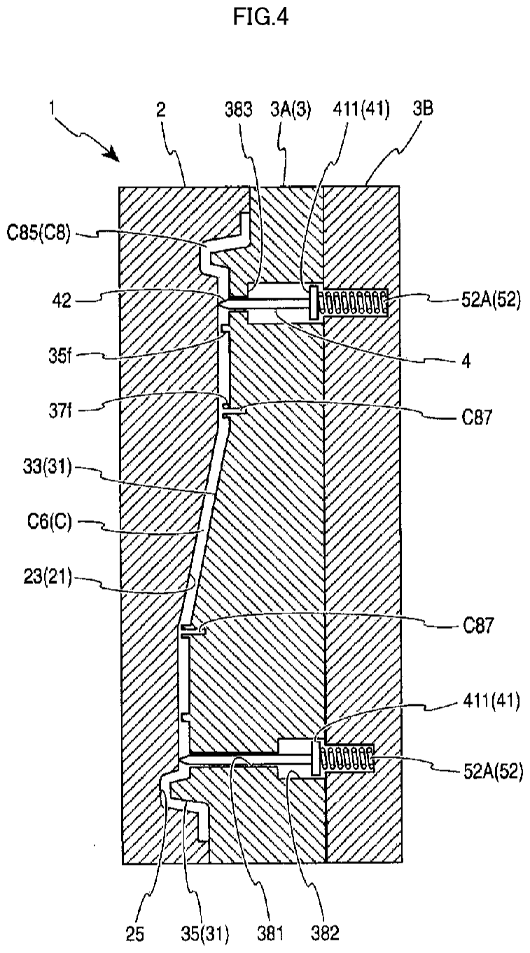

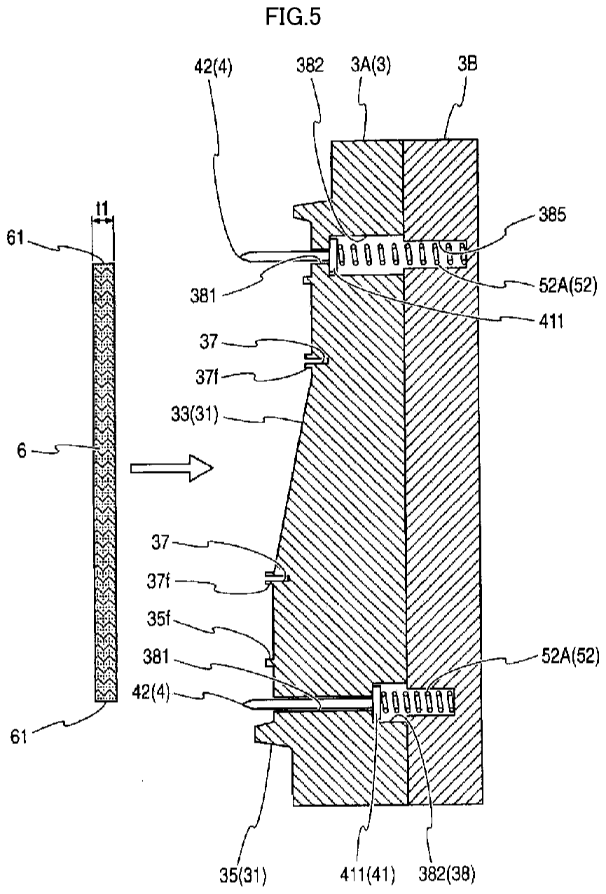

A method of manufacturing composite member, and mold used therein is discussed. The composite member P is, for example, a vehicle product of an automobile or the like. The composite member P is an integral body of the panel portion 7 configured from the porous sheet 6 (porous plate member) and the resin molded portion 8 such as the frame portion 85 configured from resin. The composite member P of the present exemplary embodiment is applied to the undercover of an engine as illustrated in FIG. 1. The composite member P is manufactured using the mold 1 as illustrated in FIG. 4. A porous sheet 6 is obtained by cutting a long porous plate member into a necessary size, and the porous sheet 6 is set in one mold 3. The porous sheet 6 is then clamped by the mold and deformed into a panel portion 7 of a desired shape. Under such clamping, the resin molded portion 8 that is integral with the panel portion 7 is injection molded, and the composite member P is manufactured (FIG. 5 to FIG. 9).

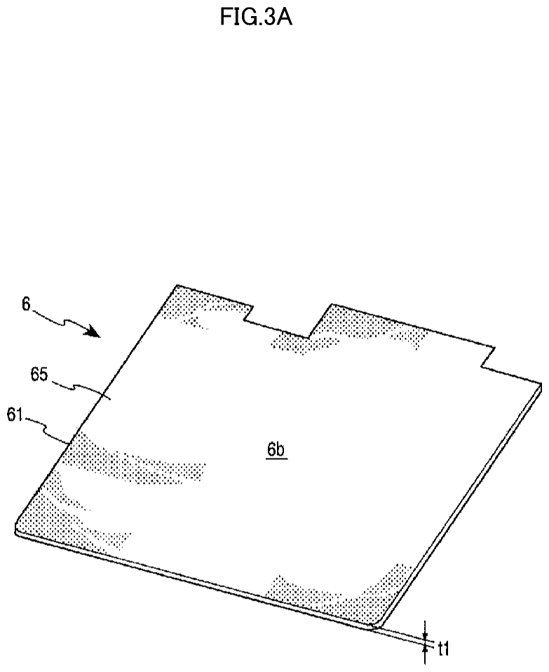

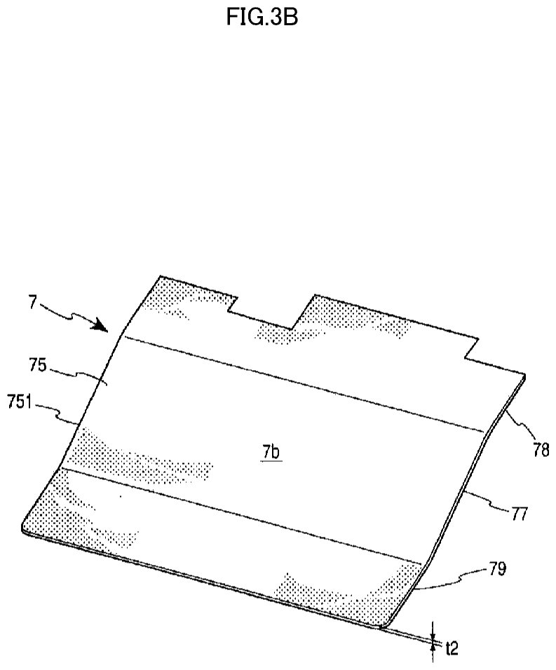

Prior to the manufacturing method of the composite member, the porous sheet 6 and the mold 1 are prepared. As illustrated in FIG. 3A, the porous sheet 6 is a plate-like member having a porous structure for sound absorption, such as a foam, a nonwoven fabric, or a felt. The porous sheet 6 refers to both a thick plate-like member and a thin sheet-like member. The porous sheet 6 according to the present disclosure is pressed and compressed by clamping by the mold, and maintains the sound absorption porous structure, even if it is thinned from an initial thickness t1 to a thickness t2 (t2<t1). As the porous sheet 6, a foam plate made of polyethylene (PE), polypropylene (PP), soft polyurethane, or the like, or a nonwoven cloth made of a thermoplastic resin such as polyethylene terephthalate (PET) or polypropylene is appropriately used. The porous sheet 6 of the present exemplary embodiment is a foam body or a nonwoven fabric, and has a plate thickness of about 10 mm to 30 mm that can be set in an erected state in a mold.

As the porous sheet 6, for example, a two-component composite type nonwoven fabric, in which a low melting point material and a high melting point material are mixed, can be used. It is preferable that each single fiber of the two-component composite type nonwoven fabric has a core of a high melting point material and a sheath of a low melting point material. After the porous sheet 6 made of a two-component composite type nonwoven fabric has been heated and the sheath portions have been softened, it is set in one mold 3, and clamped, whereby the softened sheath portions can be bonded together, and a shape pressed into a predetermined shape with a core portion that has not been softened can be maintained.

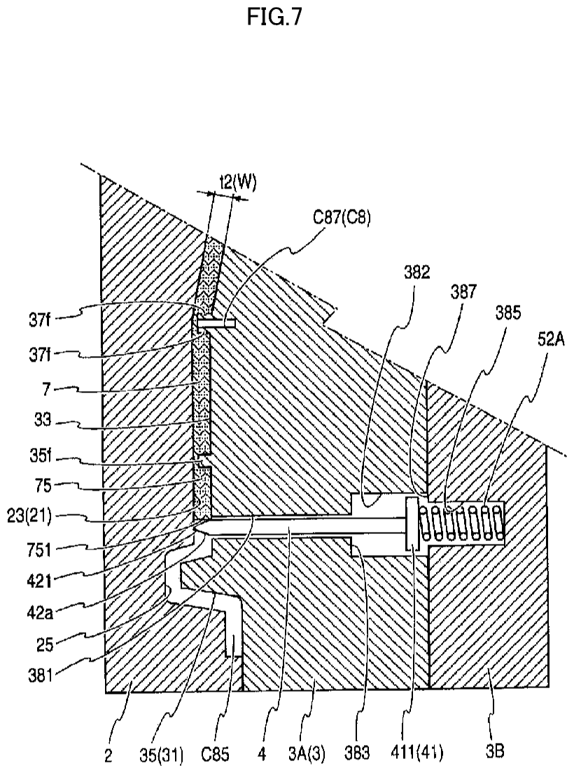

The mold 1 includes one mold 3 (here, a movable mold) and another mold 2 (here, a fixed mold), and a cavity C is formed by the molds 3, 2 by clamping them together. As illustrated in FIG. 4, the cavity C of the present exemplary embodiment includes a porous sheet cavity portion C6 in which the porous sheet 6 is disposed, and a resin molded portion cavity portion C8. The resin molded portion cavity portion C8 includes a frame portion cavity portion C85 and a crosspiece portion cavity portion C87 that surround the periphery of the porous sheet cavity portion C6. The crosspiece cavity portion C87 is provided inside the frame cavity portion C 85. The crosspiece cavity portion C87 is a portion forming a crosspiece portion functioning as a framework of the panel portion 7. As illustrated in FIG. 5, grooves that erect in the width direction are digged into the crosspiece forming cavity face 37 of the crosspiece portion cavity portion C87. The grooves are formed so as to cross each other in a lattice shape on the cavity face 33 of the porous sheet 6. The crosspiece cavity portion C87 is connected to the frame cavity portion C85 at both end regions thereof. As illustrated in FIG. 7, the cavity width W of the porous sheet cavity portion C6 in which the porous sheet 6 is disposed is smaller than the thickness t1 of the porous sheet 6 prior to being set in the mold 1. The porous sheet cavity portion C6 forms a cavity for providing a desired shape to the porous sheet 6. Reference numeral 35f denotes a biting projection for forming a frame portion, and reference numeral 37f denotes a biting projection for forming a crosspiece portion, each extending in a direction perpendicular to the drawing in FIG. 4. After the mold has been clamped together, the synthetic resin raw material g (hereafter, also simply referred to as “resin raw material”) is injected in the cavity C, whereby the biting projections 35f, 37f prevent the resin raw material g from unnecessarily entering the inside of the porous sheet 6 from the frame portion cavity portion C85 and the crosspiece portion cavity portion C87.

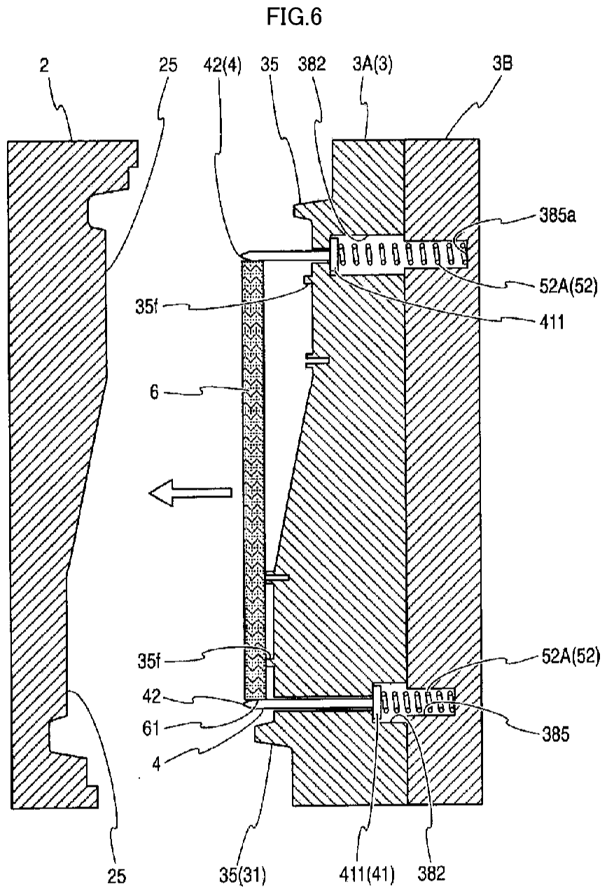

In the movable mold 3, the movable pin 4 and the elastic body 52 form a pair. Plural pairs of the movable pin 4 and the elastic body 52 are provided to the movable mold 3. A housing portion 38 for housing each elastic body 52 is provided to the movable mold 3. When the base end portion 41 of the movable pin 4 is contacted to the elastic body 52, an elastic restoring force acts on the movable pin 4 (from the cavity face of the movable mold 3) in a projecting direction, and the movable pin 4 projects out toward the cavity C side from the cavity face 35 for forming the frame portion. An oblique face portion 42a that is inclined with respect to the cavity face 25, for forming the frame portion, of the fixed mold 2, serving as a portion facing the leading end portion 42, is formed at the leading end portion 42 of the projecting movable pin 4 (see FIGS. 6 and 7).

Specifically, as illustrated in FIGS. 4 and 5, a flange 411 is formed at the base end portion 41 of the movable pin 4. A small hole portion 381 that is slightly larger than the pin diameter of each movable pin 4, and a large hole portion 382 that is slightly larger than the flange 411 are provided side-by-side in the thickness direction of the mold body 3A of the movable mold 3. A hole that penetrates the mold body 3A is formed by the small hole portion 381 and the large hole portion 382. A concave hole 385 for housing the elastic body 52 is provided at a face of the auxiliary board 3B at which the penetrating hole faces. When the mold body 3A and the auxiliary board 3B are combined, a housing portion 38 that houses the movable pin 4 is formed by the small hole portion 381, the large hole portion 382, and the concave hole 385. The flange 411 is provided so as to be capable of moving inside the large hole portion 382. The flange 411 is movable toward the pin axis direction of the movable pin 4 inside the large hole portion 382. One end of the elastic body 52 made of the spring 52A is anchored in the hole bottom 385a of the concave hole 385, and the other end of the elastic body 52 contacts the bottom face of the flange 411, also serving as a base end face of the movable pin 4, and the spring 52A is housed in the housing portion 38. There is no need to apply a load to the spring 52A, but in the present exemplary embodiment, the spring 52A is provided in the housing portion 38 in a slightly compressed state. Note that the spring 52A is employed as the elastic body 52 of the present exemplary embodiment from the perspective of ease of fine adjustment of the elastic biasing force and ease of use; however, rubber, foam, or the like may also be employed. The leading end portion 42 of the movable pin 4 that has received the elastic restoring force of the elastic body 52 projects out from the cavity face 35, as illustrated in FIG. 5. Plural movable pins 4 from which the leading end portion 42 projects out in this manner are provided to the mold 1. The outer peripheral edge 61 of the porous sheet 6 is contacted to the movable pin 4, such that the porous sheet 6 is positioned at the cavity face 33 for the porous sheet 6 at the movable mold 3 side.

In the mold 1 illustrated in FIG. 4, the movable mold 3 is moved horizontally with respect to the fixed mold 2 and clamped together by an injection molding machine of a horizontal mold type. The porous sheet 6 has a plate thickness of 10 mm to 30 mm, such that when the porous sheet 6 is placed on the movable pin 4 as illustrated in FIGS. 5 and 6, the porous sheet 6 can be erected on the movable pin 4, and the porous sheet 6 can be positioned in the mold 1 in this state. Namely, the lower edge of the porous sheet 6 is contacted so as to be supported by the movable pin 4, and the porous sheet 6 is positioned in the movable mold 3 in this state. It is more preferable to configure the movable pin 4 so as to contact the upper edge of the porous sheet 6 as well. When the porous sheet 6 is set slightly larger than the distance between the upper edge and the lower edge at which the movable pin 4 is provided, the porous sheet 6 is firmly held by the movable pin 4, and can be easily erected. Providing additional movable pins (not illustrated in the drawings) so as to contact both side edges of the porous sheet 6 also enables the porous sheet 6 to be more easily erected. As illustrated in FIG. 3, it is preferable to use a porous sheet 6 having a substantially rectangular shape. The plural movable pins 4 disposed along the rectangular outline of the porous sheet 6 enables the porous sheet 6 to be securely held and positioned inside the mold 1.

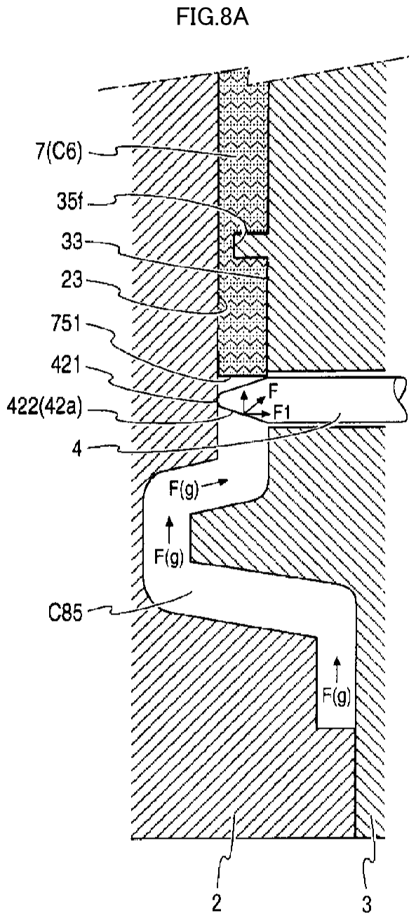

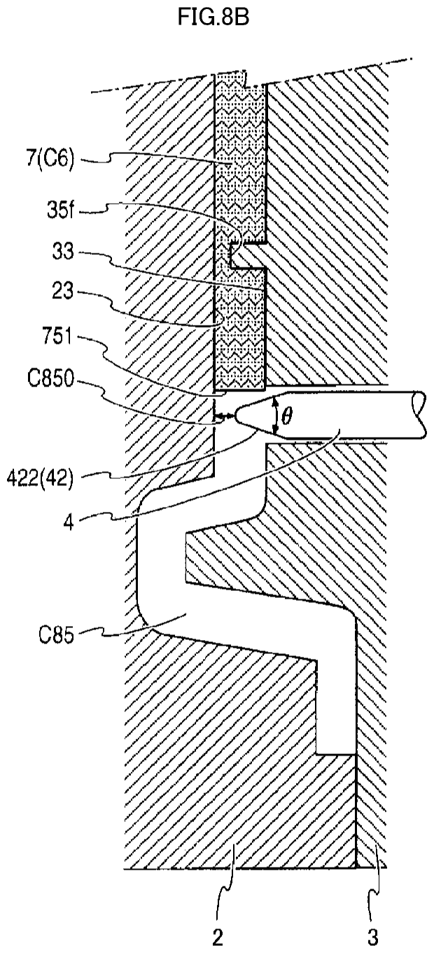

When the porous sheet 6 has been positioned in the cavity face 31 of the movable mold 3, it is clamped by the mold. When the movable pin 4 contacts the cavity face 25 of the fixed mold 2 due to clamping, the spring 52A is compressed and the movable pin 4 is retracted, whereby the porous sheet 6 is deformed into the shape of the panel portion 7 (FIG. 7). As described above, at the leading end portion 42 of the movable pin 4, there is formed an oblique face portion 42a that is inclined with respect to the cavity face at which it abuts. In the present exemplary embodiment, an oblique face portion 42a of a conical tapered face 422 that uniformly extends radially outward from the pin axis center of the movable pin 4 is formed at the leading end portion 42. The flow of the synthetic resin raw material g into the cavity C acts on the oblique face portion 42a, and the movable pin 4 moves back away from the cavity face 25 of the fixed mold 2 (FIG. 8B). When the flow of the resin material g flowing in the vicinity of the leading end portion 42 of the movable pin 4 acts on the slope portion 42a, a force F in the perpendicular direction to the slope portion 42a acts on the slope portion 42a. The force F in the perpendicular direction generates a component force F1 in the horizontal direction by the slope portion 42a. The component force F1 retracts the movable pin 4.

Resin material g enters the frame portion cavity portion C85 and the crosspiece portion cavity portion C87, and the movable pin 4 is separated from the cavity face 21 of the fixed mold 2 due to its injection pressure. Thus, the resin raw material g enters the empty space C850 after the movable pin 4 has been retracted, and the resin molded portion 8 of the frame portion 85 and the crosspiece portions 87 is molded. In the mold 1 of the present exemplary embodiment, the porous sheet 6 is deformed into the shape of the panel portion 7, and the frame portion 85 and the crosspiece portions 87 are molded. The mold 1 can form the resin entry curing portion 84 that is formed by the resin raw material g penetrating into the porous sheet 6 at the outer peripheral portion 75 of the panel portion 7 corresponding to the peripheral portion 851 of the frame portion opening 850. In addition, the mold 1 can form the resin entry curing portion 875 that is formed by the resin raw material g penetrating into the porous sheet 6, also at the base portion of the crosspiece portion 87. The resin entry curing portions 84, 875 enable the composite member P in which the resin molded portion 8 is firmly joined to the panel portion 7 to be formed.

The composite member P is manufactured, for example, as follows, using the above-described mold 1 and the porous sheet 6. First, the mold 1 is brought into a mold open state. In this state, the base end portion 41 of the movable pin 4 contacts the spring 52A, and the leading end portion 42 of the movable pin 4 projects out of the cavity face 35 of the movable mold 3 forming the rear face of the composite member P (FIG. 5). The flange 411 on which the elastic restoring force of the spring 52A acts contacts the enlarged diameter inside wall 383 extending from the small hole portion 381 to the large hole portion 382, and the flange 411 stops, and the leading end portion 42 of the movable pin 4 projects out from the cavity face 31.

In such a state, the porous sheet 6 is softened by heating (pre-heating) appropriately to a predetermined temperature, and is set in the movable mold 3. The porous sheet 6 is cut into a size corresponding to the panel portion 7 in advance. Plural movable pins 4 are arrayed along an outer peripheral edge 61 of the porous sheet 6. The movable pin 4 projects out substantially horizontally from the cavity face 31 of the movable mold 3. The outer peripheral edge 61 of the porous sheet 6 is contacted to the movable pins 4, and the porous sheet 6 is positioned in the movable mold 3 (FIG. 6). Here, two movable pins 4 are provided at the upper stage of the movable mold 3, and three movable pins 4 are provided at the lower stage. The movable pins 4 provided at the upper stage are separated from each other at equal intervals. The movable pins 4 provided at the lower stage are separated from each other at equal intervals. A lower edge of the porous sheet 6 is placed on the movable pin 4 at the lower stage. The porous sheet 6 is positioned in the movable mold 3 so as to be sandwiched between the movable pin 4 at the upper stage and the movable pin 4 at the lower stage. Since plural movable pins 4 are provided so as to surround the outer peripheral edge 61 of the porous sheet 6, the movable pin 4 in a state in which the porous sheet 6 is erecting can be firmly held, and the porous sheet 6 can be set in the movable mold 3 without dropping off the porous sheet 6 from the movable pin 4. Note that a horizontal type injection molding machine in which the movable mold 3 moves horizontally with respect to the fixed mold 2 is widely used. Since a mold used in a horizontal mold type injection molding machine has a cavity face extending in the vertical direction, there are no members or portions that support the porous sheet 6, and it is difficult to set the porous sheet 6 in the mold. However, the mold 1 of the present exemplary embodiment can be easily positioned in the mold 1 in a state in which the porous sheet 6 is erected by the movable pin 4.

Next, the mold 1 is clamped, the movable pin 4 is retracted against the elastic restoring force of the spring 52A, in a state in which the movable pin 4 abuts the cavity face 25 of the fixed mold 2, and the porous sheet 6 is deformed into the shape of the panel portion 7 (FIG. 7). As clamping progresses, the movable pin 4 projecting out of the cavity face 31 of the movable mold 3 contacts the cavity face 25 of the fixed mold 2. Thereafter, the spring 52A is compressed by clamping, the leading end 421 is pushed back from the point in FIG. 6 to the point in FIG. 7 at the time of completion of clamping, and is retracted. The movable pin 4 is provided so as to be capable of moving through the small hole portion 381 provided in the movable mold 3, and so the leading end 421 of the movable pin 4 stops in the state of FIG. 7 when it has contacted the cavity face 21 (specifically, the cavity face 25) of the fixed mold 2. By this clamping, the porous sheet 6 is sandwiched and compressed by the cavity face 31 and the cavity face 21. Initially, the porous sheet 6 with the thickness t1 is compressed in the thickness direction, and the porous sheet cavity portion C6 has a thickness t2 illustrated in FIG. 3B, and is deformed into the shape of the panel portion 7 maintaining the sound absorption porous structure.

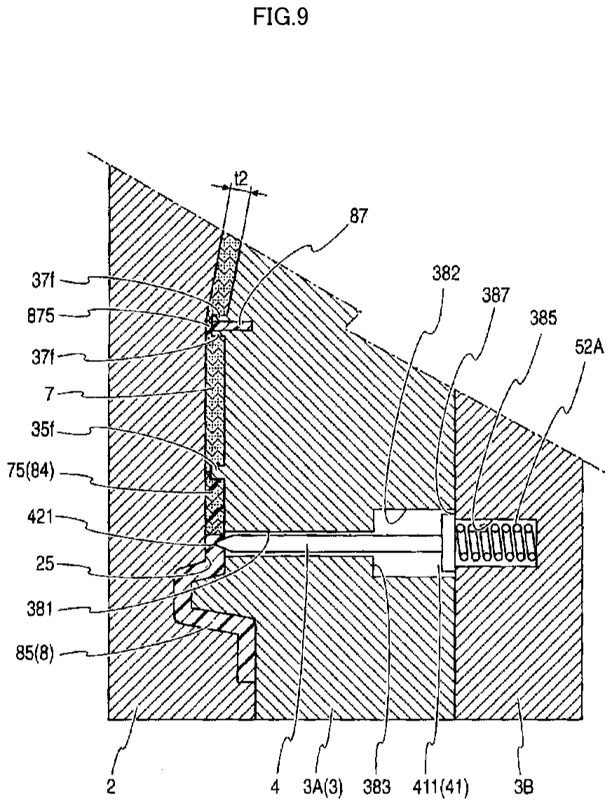

In the present exemplary embodiment, the porous sheet 6 of FIG. 3A having a sound absorption function is used. Even if the porous sheet 6 is compressed, the shape of the panel portion 7 including the upper step face 78 and the lower step face 79 can be deformed while sandwiching the oblique face 77 as illustrated in FIG. 3B, for example, without losing the sound absorption function. However, even with the panel portion 7 that has been compressed and increased in strength, the porous structure for sound absorption is maintained in the panel portion 7, and so it is difficult to say that it is robust, and so rigidity and mechanical strength required for the composite member P may be insufficient. However, in the present exemplary embodiment, in order to resolve the above-mentioned lack of strength, the frame portion 85 and the crosspiece 87 for maintaining the shape of the panel portion 7 are integrally formed with the panel portion 7 (FIG. 9). Thus, situations in which rigidity or mechanical strength is insufficient are unlikely to occur in the composite member P.

In the present exemplary embodiment, a situation in which holes due to the movable pin 4 appear in the design face of the product, if it is left as it is, is resolved by employing the movable pin 4 in which the oblique face portion 42a is provided at the leading end portion 42. Since the movable pin 4 is provided with the oblique face portion 42a, the leading end 421 of the movable pin 4 retracts from the cavity face 25 of the fixed mold 2 due to the injection pressure of the resin raw material g, and no hole is generated by the movable pin 4 on the design face.

More detailed explanation follows. When the resin material g is injected after the clamping, the movable pin 4 is pushed by the flow of the resin material g and retracted away from the cavity face 25 of the fixed mold 2. Resin raw material g enters into the frame portion cavity portion C85 and the crosspiece portion cavity portion C87 including an empty space C850 formed by retracting the movable pin 4, and further into the outer peripheral portion 75 of the panel portion 7, thereby forming a resin molded portion 8 (see FIG. 9). Under clamping, the resin material g is injected into the frame portion cavity portion C85 through a runner and a gate, not illustrated in the drawings, from a nozzle of the injection molding machine. Here, a polypropylene resin raw material is used as the resin raw material g. The oblique face portion 42a is provided at the leading end portion 42 of the movable pin 4, such that in the cavity C, the oblique face portion 42a is separated from the cavity face 25 of the fixed mold 2, except for the leading end 421. Thus, the oblique face portion 42a of the movable pin 4 receives force from the resin material g flowing along the cavity face 21.

Here, the movable pin 4 is formed by machining a round bar. In the present exemplary embodiment, the oblique face portion 42a is a conically curved tapered face 422 that is point-symmetric with respect to the axis center of the movable pin 4. Since the tapered face 422 in the shape of a conically curved face is evenly spread out radially outward from the leading end 421, the movable pin 4 is pushed backward with respect to the axial direction by a component force F1, and is retracted. When pushed by the force component F1, the movable pin 4 retracts to a position in which the leading end 421 of the movable pin 4 is separated from the cavity face 21. Thus, an empty space C850 is formed between the cavity face 21 and the leading end 421 of the movable pin 4 (FIG. 8B). In the present exemplary embodiment, at a position in which the component force F1 that pushes the movable pin 4 toward the rear exceeds the elastic restoring force of the spring 52A, the flange 411 contacts the projecting face 387 and stops. As illustrated in FIG. 8B, it is preferable that the tapered face 422 provided to the movable pin 4 be formed in a shape that is pointed at an angle θ from the leading end 421. It is more preferable that the angle θ be set at an obtuse angle than an acute angle in order to increase the force component F1.

After the movable pin 4 has separated from the cavity face 21 of the fixed mold 2, injection of the resin material g into the cavity C further proceeds. The resin raw material g enters the frame portion cavity portion C85 and the crosspiece portion cavity portion C87. In addition thereto, the resin raw material g enters the porous sheet 6 of the outer peripheral portion 75 of the panel portion 7 in which the porous structure is maintained, and the resin molded portion 8 including the resin entry curing portion 84 is formed. Note that the resin raw material g attempts to enter the main body of the panel portion 7 maintained in a porous structure from the outer peripheral portion 75 of the panel portion 7, but is blocked by the biting projection 35f of the frame portion formation. The resin material g attempts to enter the main body of the panel portion 7 from the base portion of the crosspiece cavity portion C87, but is blocked by the biting projection 37f of the crosspiece formation. Namely, the projections 35f, 37f bite into the panel portion 7 more than the cavity face 31 in the vicinity thereof due to clamping, and the portion of the panel portion 7 having the porous structure is further compressed and made denser, thereby making it difficult for the resin material g to permeate this portion. Namely, the projections 35f, 37f prevent the resin material g from entering further toward the main body side of the panel portion 7 from the position in which the projections 35f, 37f are provided, and so the sound absorption performance is prevented from being reduced.

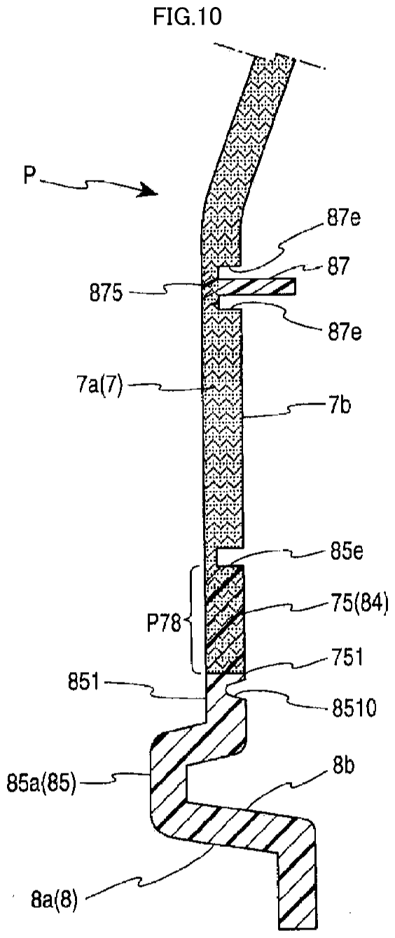

On the other hand, since the biting protrusion 35f for frame portion formation is formed to be slightly smaller than the outer circumference of the panel portion 7, the resin entry curing portion 84 that has been cured due to the resin raw material g entering the porous structure in only the region of the outer circumferential portion 75 of the panel portion 7 is molded. Thus, the resin entry curing portion 84 and the outer peripheral portion 75 of the panel portion 7 are integral with each other, and the joint region P78 is formed. In the crosspiece cavity portion C87, a resin entry curing portion 875 that has entered the panel portion 7 from the base portion of the crosspiece 87 is formed. Thus, a composite member P is formed in which the panel portion 7 is integrally formed with the resin molded portion 8 including the resin entry curing portion 84 formed at the outer peripheral portion 75 of the panel portion 7, the frame portion 85, the crosspiece 87, and the resin entry curing portion 875 formed at the base portion of the crosspiece 87. The recessed mark 8510 of the movable pin 4 remains in the frame portion 85 (FIG. 10), but this occurs at the rear face 8b side of the composite member P, not on the design face 8a side, and hence, it does not pose a problem.

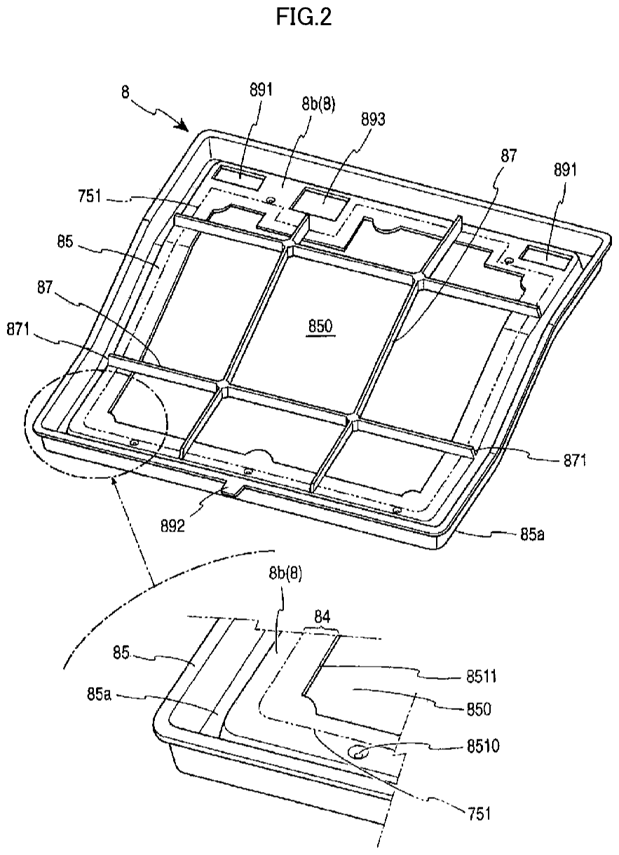

When the resin molded portion 8 is demolded after molding, the composite member P in which the resin molded portion 8 holding the shape of the panel portion 7 is integrally formed with the panel portion 7 is obtained. 85a indicates a frame reinforcing portion, 85e and 87e indicate seal marks (not illustrated in FIGS. 1 and 2) left by the biting projections 35f and 37f, 871 indicates an end portion of the crosspiece, 891 indicates an attachment port to a mating member, 892 indicates an attachment piece to a mating member, and 893 indicates an opening for a separate component.

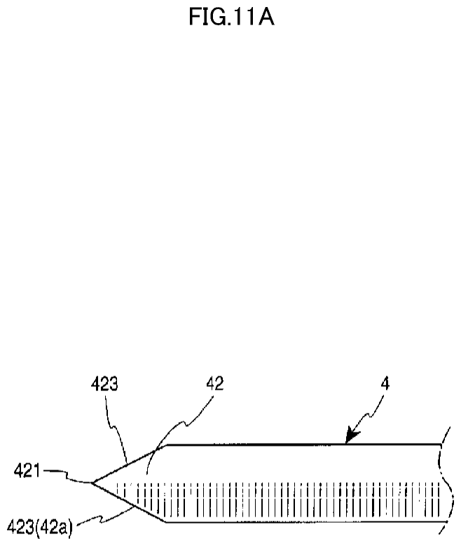

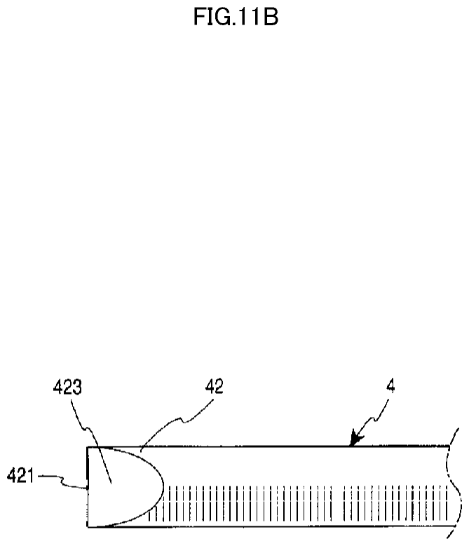

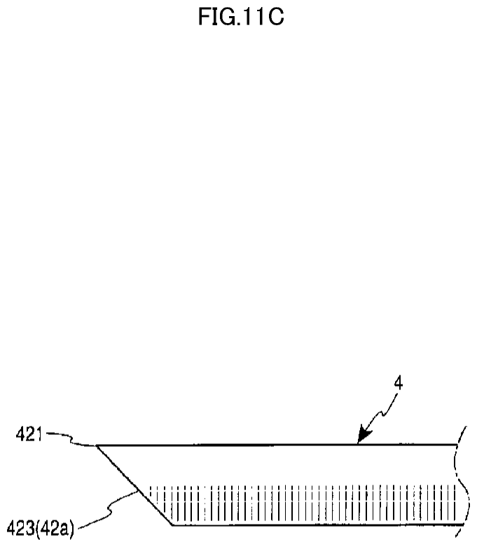

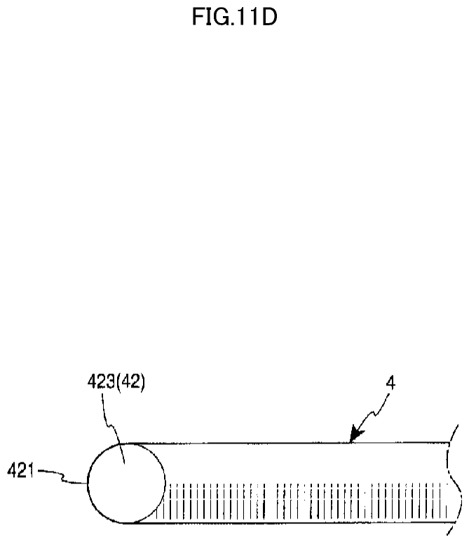

FIGS. 11A and 11B illustrate a leading end portion 42 of a movable pin 4 of a first modified example. FIGS. 11C and 11D illustrate a leading end portion 42 of a movable pin 4 of a second modified example. It is sufficient that the leading end portion 42 of the movable pin 4 has an oblique face portion 42a that is inclined with respect to the cavity face 21 of the fixed mold 2 (the another mold) to which the leading end portion 42 of the movable pin 4 corresponds. For example, as illustrated in FIGS. 11A and 11B, the leading end portion 42 of the movable pin 4 may be shaped like a leading end of a minus driver. This shape is obtained, for example, by leaving a center portion of a leading end of a round bar shaped member as a flat leading end 421, and cutting both sides of this leading end 421 obliquely. Oblique face portions 423 are formed at both sides. Alternatively, the leading end portion 42 of the movable pin 4 can have the shape illustrated in FIGS. 11C and 11D. The shapes illustrated in FIGS. 11C and 11D are obtained, for example, by obliquely cutting the peripheral surface of a round bar shaped member at an arbitrary point. Thus, an oblique face portion 423 is formed at a leading end of a round bar shaped member. In either of the shapes illustrated in FIGS. 11A and 11B, or the shapes illustrated in FIGS. 11C and 11D, when the movable pin 4 contacts the cavity face 21 of the fixed mold 2, the oblique face portion 42a is in a state separated from the cavity face 21, such that the movable pin 4 can be retracted toward the movable mold 3 on receiving force from the resin material g.

Unlike in the above exemplary embodiments, one of the molds may be the fixed mold 2, and the movable pin 4, the elastic body 52, the housing portion 38, and the like may be provided to the fixed mold 2 (not illustrated). Namely, the fixed mold 2 may be configured such that the base end portion of the movable pin 4 contacts the fixed mold 2 with the elastic body 52 interposed therebetween. Note that in such cases, the another mold is a movable mold. In FIG. 4, the movable pin 4, the elastic body 52, and the housing portion 38 existing in the movable mold 3 at the right side of the figure move to the fixed mold 2 at the left side. In such cases, when the mold is open, the outer peripheral edge 61 of the porous sheet 6 is contacted to the movable pin 4, and the porous sheet 6 is positioned in the fixed mold 2.

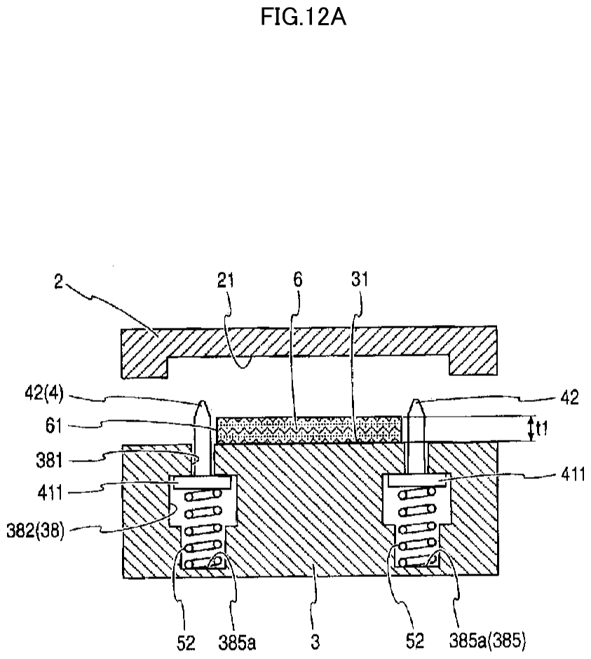

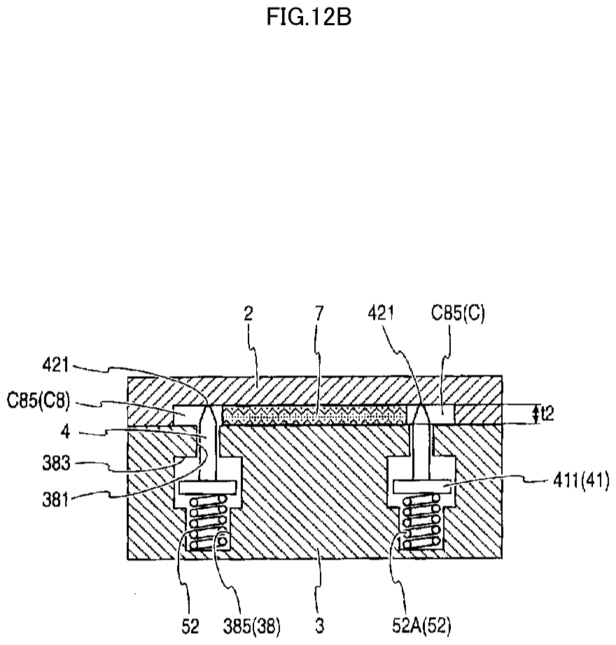

FIGS. 12A and 12B illustrate a mold according to a third modified example of the present disclosure. The present disclosure may be applied to a vertical type injection molding machine in which a movable mold moves in a perpendicular direction with respect to a fixed mold. One of the molds 3 may be a lower mold as illustrated in FIGS. 12A and 12B, and the movable pin 4, the elastic body 52, and the housing portion 38 may be provided to the lower mold 3. In the present modified example, the another mold 2 is the upper mold. The movable pin 4 is provided to the lower mold 3, and the porous sheet 6 is positioned in the lower mold 3 such that the outer peripheral edge 61 of the porous sheet 6 contacts the movable pin 4, thereby positioning the porous sheet 6 in the lower mold 3. In injection molding machines of the horizontal type, there is sometimes a problem in that it is difficult to position the porous sheet 6 in a state in which it is too thin to erect, but in injection molding machines of the vertical type, such a problem does not occur.

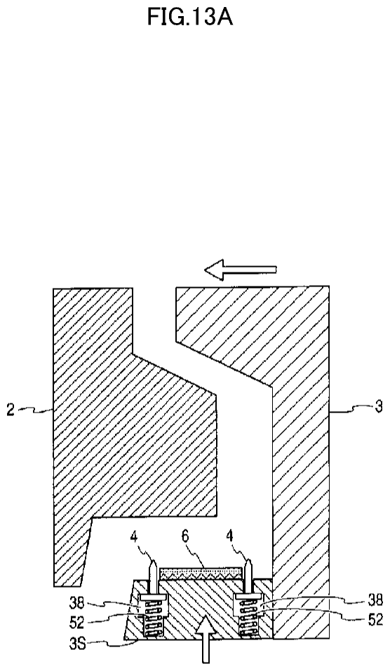

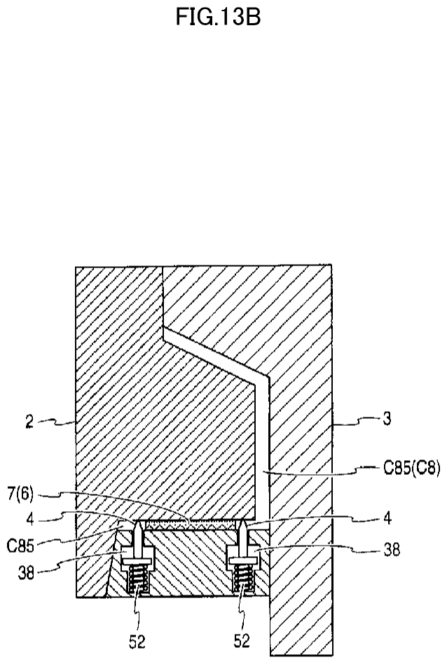

FIGS. 13A and 13B illustrate a mold according to a fourth modified example of the present disclosure. As illustrated in FIGS. 13A and 13B, the movable mold (one mold) may be a divided mold. In the illustrated example, the movable mold includes a first mold 3 and a second mold 3S. The movable pin 4, the elastic body 52, and the housing portion 38 can be provided to the second mold 3S. The another mold 2 is a fixed mold. The first mold 3 moves in the horizontal direction, and the second mold 3S moves in the vertical direction. In such cases as well, the porous sheet 6 is placed and set on the cavity face 31 of the second mold 3S, such that a thin porous sheet 6 can be used. Note that in FIGS. 12A to 13B, other configuration is the same as in the present exemplary embodiment, and therefore, the same reference numerals are appended to the same configuration as in the present exemplary embodiment, and explanation thereof is omitted.

### Effect

The manufacturing method of the composite member P configured in this manner, and the mold 1 used in the same, are light in weight because the finished product includes the light porous sheet 6. Since the porous structure is maintained in the panel portion 7, the composite member P has sound absorption characteristics.

The present disclosure enables the porous sheet 6 to be set in the mold 1 with the movable pin 4 in contact with the outer peripheral edge 61 of the porous sheet 6, such that difficult operation of inserting the movable pin through the hole is not required, unlike in Patent Document 1. There is also no deterioration in sound insulation performance or sound absorption performance due to opening of the holes.

Since the movable pin 4 is positioned against the outer peripheral edge 61 of the porous sheet 6, a porous sheet 6 of a necessary size can be employed instead of a porous sheet of an unnecessarily large size. When the mold is demolded, the composite member P can be taken out as it is to form a product. Namely, unlike in Patent Document 2, no extra length portion is generated in the composite member, and a post-process of cutting the extra length portion after mold opening is unnecessary.

Moreover, the oblique face portion 42a that is inclined with respect to the cavity face 25 of the another mold 2 that faces the leading end portion 42 of the movable pin 4 is formed. Thus, the oblique face portion 42a receives the flow of the synthetic resin material g, the movable pin 4 moves away from the cavity face 25 of the another mold 2, and retracts. The resin raw material g enters the frame portion cavity portion C85 including the empty space C850 after retraction of the movable pin 4, and the resin molded portion 8 integrally formed with the porous sheet 6 can be molded. There is no hole through which the movable pin 4 is pulled out in the design face 8a of the resin molded portion 8. Thus, unlike in Patent Document 1, no hole through which the positioning pin has passed remains in the product, and so the appearance is not negatively affected.

An oblique face portion 42a is provided at a leading end portion 42 of the movable pin 4. This enables the movable pin 4 to be conveniently retracted from the cavity face 25 of the another mold due to the flow of the resin material g into the cavity. Namely, in the mold 1 of the present exemplary embodiment, no new device is required in order to retract the movable pin 4 from the cavity face 25. Since the resin material g enters the empty space C850 after retraction, and the frame portion 85 is formed, the composite member P without the hole by the movable pin 4 is formed, in the design face 8a. No holes are left in the product, such that the appearance is not negatively affected and the sound insulation performance or sound absorption performance is not deteriorated. There is also no need for labor to close the hole by post-processing. Even if the recessed mark 8510 of the movable pin 4 remains, it does not appear on the design face of the product, and so does not pose a problem.

More specifically, it is common to leave the product in the movable mold during demolding. This makes it necessary to provide a draft angle of the product in the fixed mold. In FIG. 4, when the movable pin 4, the elastic body 52, and the housing portion 38 are provided to the fixed mold 2 instead of the movable mold 3, the movable pin 4 is assisted so as to leave the product in the movable mold during demolding, due to the elastic restoring force of the elastic body 52. This enables a draft angle of the fixed mold to be reduced, and enables design constraints on the design aspect of the product to be alleviated. When the porous sheet 6 is made of a nonwoven cloth in which a low melting point material and a high melting point material are mixed, the nonwoven cloth is heated, then clamped by the mold, and the porous sheet 6 is deformed into a shape of the panel portion 7 using a high melting point fiber material, and its shape can be easily maintained with adhesiveness of the low melting point fiber material. When a nonwoven cloth of core-sheath structure fibers is used, the sheath portion is made a low melting point fiber, which is responsible for thermal bonding, and can be smoothly processed into the panel portion 7 of the sound absorption porous structure.

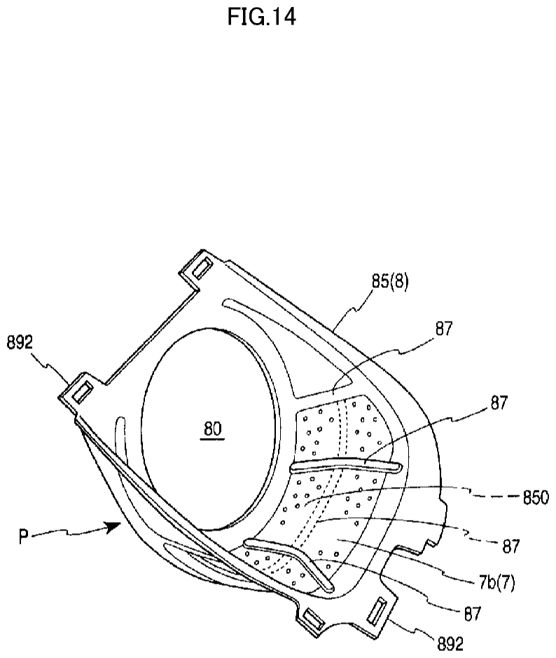

Note that the present disclosure is not limited to those illustrated in the above exemplary embodiments, and various modifications can be made within the scope of the present disclosure, depending on the purpose and application. Shape, size, number, material, and the like of the mold 1, the one mold 3, the another mold 2, the movable pin 4, the elastic body 52, the porous sheet 6, the panel portion 7, the resin molded portion 8, and the like can be appropriately selected according to the application. The composite member P of the present exemplary embodiment is an engine undercover, but it is also applicable to an undercover of an instrument panel, and is also applicable, of course, to, for example, a cooling duct of a battery in FIG. 14. In FIG. 14, reference numeral 80 denotes a duct connection port, and in other respects, the same reference numerals as those in the exemplary embodiments are the same or corresponding portions as those in the respective embodiments. Note that in the exemplary embodiments, heating (pre-heating) was performed to a predetermined temperature prior to setting the porous sheet 6 in the movable mold 3; however, heating may not be performed. Heating (pre-heating) is not necessary, depending on the material of the porous sheet 6 and the shape to be shaped.

### Second Exemplary Embodiment

A method of manufacturing composite member, and mold used therein will be discussed. The composite member P of the present exemplary embodiment is a vehicle product such as an automobile or the like, such as an undercover of an instrument panel. The composite member P includes a panel portion 107 including the porous sheet 106 in a three-dimensional shape, and a resin molded portion 108 including a frame portion 185 and a crosspiece portion 187. The three-dimensional shape of the porous sheet 106 is maintained by the resin molded portion 108.

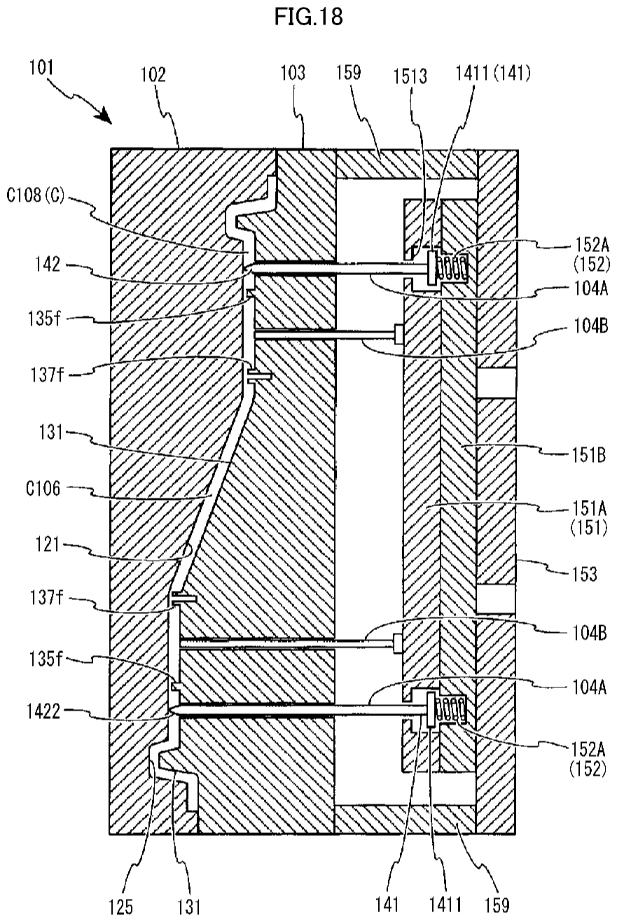

The composite member P is manufactured using a mold 101 as illustrated in FIG. 18. A porous sheet 106 (a porous plate member) is obtained by cutting a long porous plate member into a necessary size, and the porous sheet 106 is set in one mold 103 (here, a movable mold). Next, the porous sheet 106 is clamped by the mold, pressed and deformed into a three-dimensional shape. The resin molded portion 108 is injection molded in the clamping state, and a composite member P in which the porous sheet 106 and the resin molded portion 108 are integrally formed is manufactured. Note that in the present disclosure, pressing the porous sheet 106 and deforming the porous sheet into a certain shape is sometimes referred to as shaping.

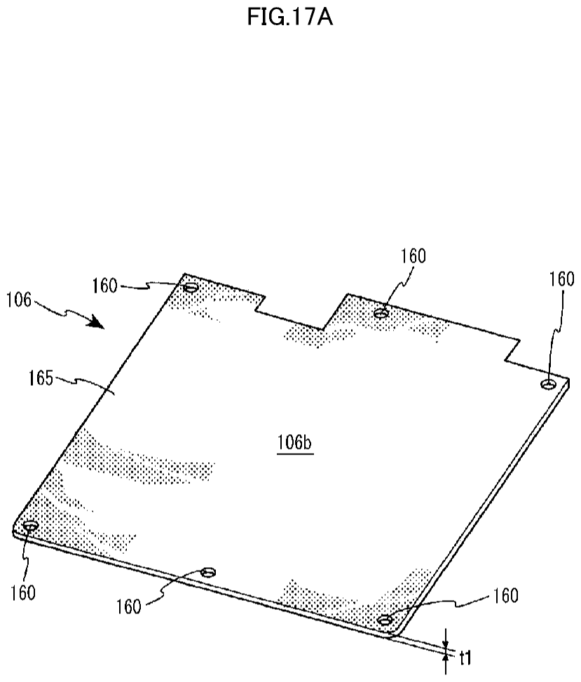

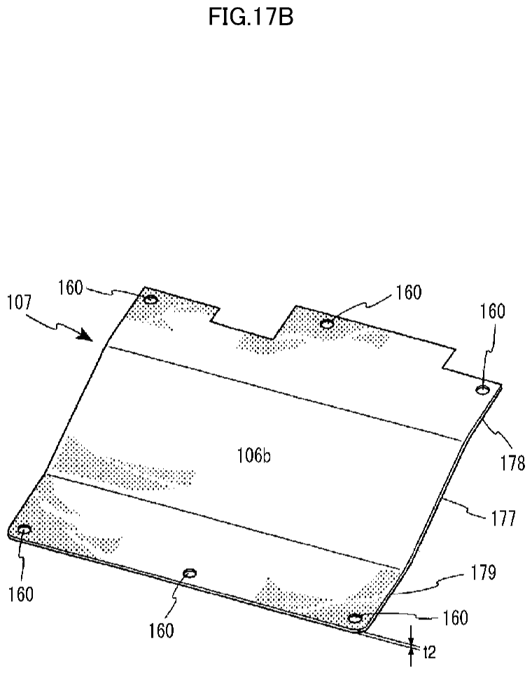

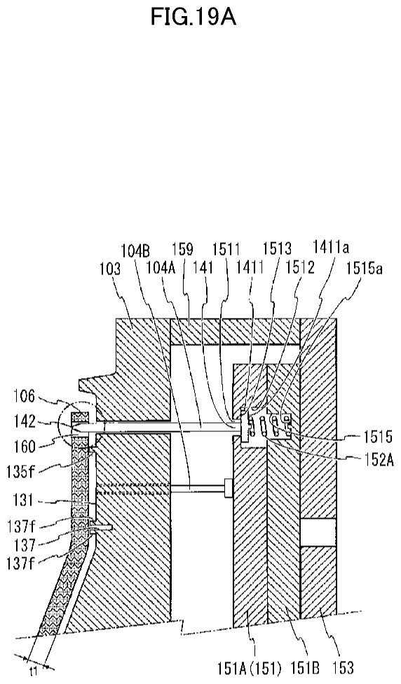

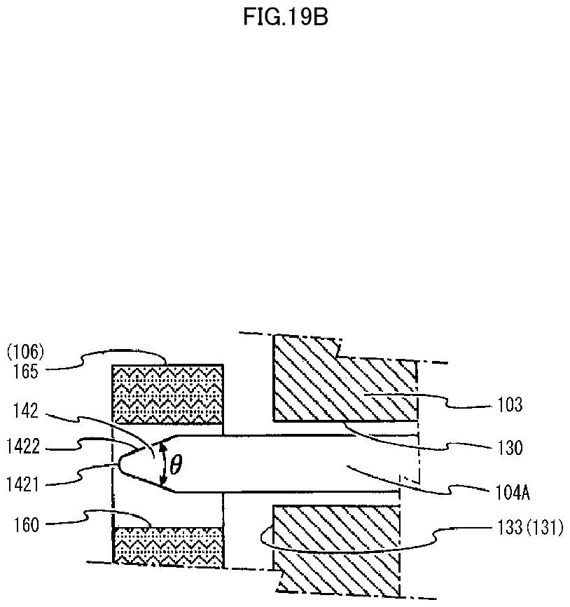

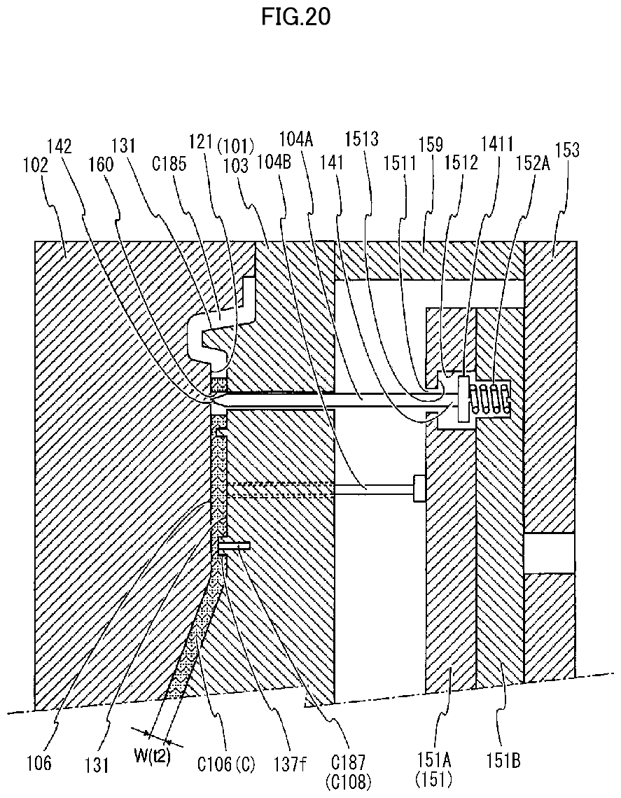

Prior to manufacturing the composite member P, the porous sheet 106 and the mold 101 are prepared. As illustrated in FIG. 17A, the porous sheet 106 is a sheet-like body having a porous structure for sound absorption, such as a nonwoven fabric or a foam body. The porous sheet 106 refers to both a thin sheet-like member and a thick plate-like member. As illustrated in FIGS. 19A and 20, the porous sheet 106 is pressed and compressed by clamping by the mold, and retains the sound absorption porous structure, even if it is thinned from an initial thickness t1 to a thickness t2 (t2<t1). As the porous sheet 106, a nonwoven cloth made of a thermoplastic resin such as polyethylene terephthalate (PET) or polypropylene (PP) can be used.

As the porous sheet 106, for example, a two-component composite type nonwoven fabric in which a low melting point material and a high melting point material are mixed together can be used. It is preferable that each single fiber of the two-component composite type nonwoven fabric has a core of a high melting point material and a sheath of a low melting point material. After the porous sheet 106 made of a two-component composite type nonwoven fabric is heated and the sheath portion is softened, it is set in one mold 103, and clamped by the mold, whereby the softened sheath portions are bonded together, and the shape pressed into a predetermined shape by a core portion that is not softened can be maintained.

In the present exemplary embodiment, six (plural) through-holes 160 that are inserted into the movable pin 104A are provided at the outer peripheral portion of the porous sheet 106. Three through-holes 160 are respectively provided separately along upper and lower edges of each porous sheet 106. When the movable pin 104A of the mold 101 is inserted through each of the through-holes 160, the porous sheet 106 can be positioned in the mold 101.

The mold 101 includes plural projecting pins 104B that project the composite member P out from the cavity face 131, at a side of one mold 103 (here, a movable mold). As illustrated in FIGS. 19A and 19B, some of these projecting pins 104B are movable pins 104A that have a function of positioning the porous sheet 106 in the cavity. Regarding the present mold 101, of the ten or more projecting pins 104B, the six projecting pins 104B disposed at positions corresponding to the six through-holes 160 are the movable pins 104A having a positioning function. The movable pin 104A includes a leading end portion 142 and a base end portion 141. As illustrated in FIG. 18, the base end portion 141 of the movable pin 104A is attached to the ejector plate 151 by an elastic body 152. When the leading end portion 142 of the movable pin 104A projects out of the cavity face 131 of the movable mold 103 due to the elastic restoring force of the elastic body 152, the movable pin 104A exhibits a positioning function. The leading end portion 142 of the movable pin 104A has an oblique face portion that is inclined with respect to the cavity face 121 of the another mold 102 (here, a fixed mold) that the leading end portion 142 faces. A conical tapered face 1422 that extends uniformly from a leading end 1421 toward the outside in the radial direction of the axial center of the movable pin 104A is provided at the leading end portion 142.

More specifically, as illustrated in FIGS. 18 to 19B, a flange 1411 is formed at the base end portion 141 of the movable pin 104A. The upper ejector plate 151A is provided with a small hole portion 1511 with an inside diameter that is approximately the same as the pin diameter of the movable pin 104A, and a large hole portion 1512 with an inside diameter that is approximately the same as the outside diameter of the flange 1411. Small hole portions 1511 and large hole portions 1512 are provided side-by-side in the plate thickness direction, and pass through the upper ejector plate 151A. A concave hole 1515 for housing the elastic body 152 is provided at a portion of the lower ejector plate 151B that faces the hole formed by the small hole portion 1511 and the large hole portion 1512. A flange 1411 is installed so as to be capable of moving in the axial direction of the movable pin 104A, in a large hole portion 1512 formed when the upper ejector plate 151A and the lower ejector plate 151B are combined. One end of an elastic body 152 including a spring 152A is anchored in a hole bottom 1515a of the recessed hole 1515, and a spring 152A is in a compressed state, with another end of the elastic body 152 contacting a bottom face 1411a of a flange 1411, also serving as a base end face of the movable pin 104A. The leading end portion 142 of the movable pin 104A that has been elastically biased by the elastic restoring force of the spring 152A projects out of the cavity face 131 of the movable mold 103 as illustrated in FIGS. 19A and 19B. When the projecting movable pin 104A is inserted into the through-hole 160 of the porous sheet 106, the porous sheet 106 is positioned and set on the cavity face 131 of the movable mold 103. Upon clamping, the movable pin 104A contacts the cavity face 121 of the fixed mold 102, the spring 152A is compressed, and the porous sheet 106 is pressed, as illustrated in FIG. 20. Note that the spring 152 A is employed as the elastic body 152 of the present exemplary embodiment from the perspective of ease of fine adjustment of the elastic restoring force and ease of use; however, rubber, foam, or the like may also be employed.

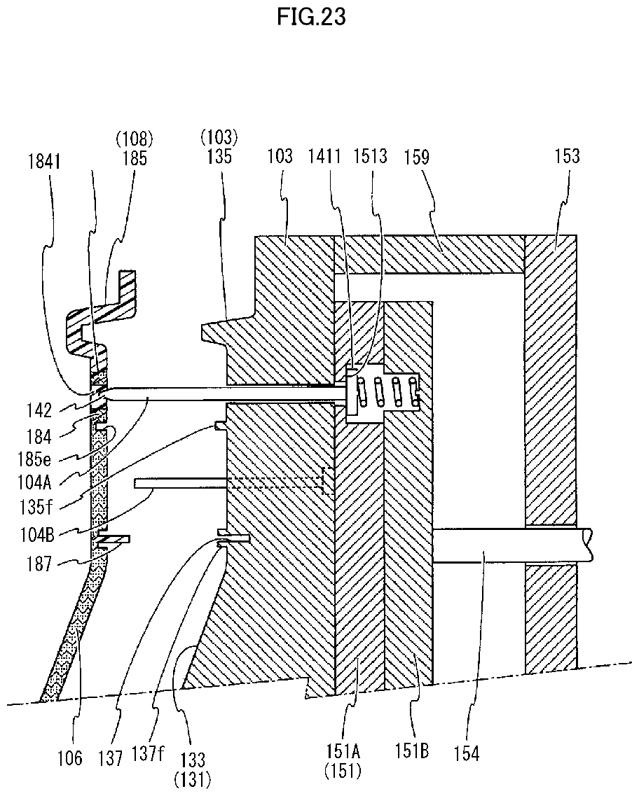

As illustrated in FIGS. 18 to 20, the cavity C formed by clamping of the mold 101 includes a porous sheet cavity portion C106 in which the porous sheet 106 is disposed, and a resin molded portion cavity portion C108. The resin molded portion cavity portion C108 includes a frame portion cavity portion C185 surrounding the porous sheet cavity portion C106, and a crosspiece portion cavity portion C187. As illustrated in FIG. 23, the crosspiece forming cavity face 137 configuring the crosspiece cavity portion C187 is provided in a groove shape carved onto the cavity face 131 of the movable mold 103. The grooves are formed so as to intersect each other in a lattice shape on a cavity face 131 forming a rear face of the porous sheet 106. The crosspiece cavity portion C187 is connected to the frame cavity portion C185 at both ends thereof. The cavity width W of the porous sheet cavity portion C106 is smaller than the thickness t1 of the porous sheet prior to being set in the mold 101. Reference numeral 135f denotes a biting projection for forming a frame portion, and reference numeral 137f denotes a biting projection for forming a crosspiece portion, each extending in a direction perpendicular to the plane of the drawings in FIG. 18. When the synthetic resin raw material g (hereafter, also simply referred to as “resin raw material”) is injected into the cavity C after clamping, the biting projections prevent injection of the resin raw material g from the frame portion cavity portion C185 and the crosspiece portion cavity portion C187 into the inside of the porous sheet 106.

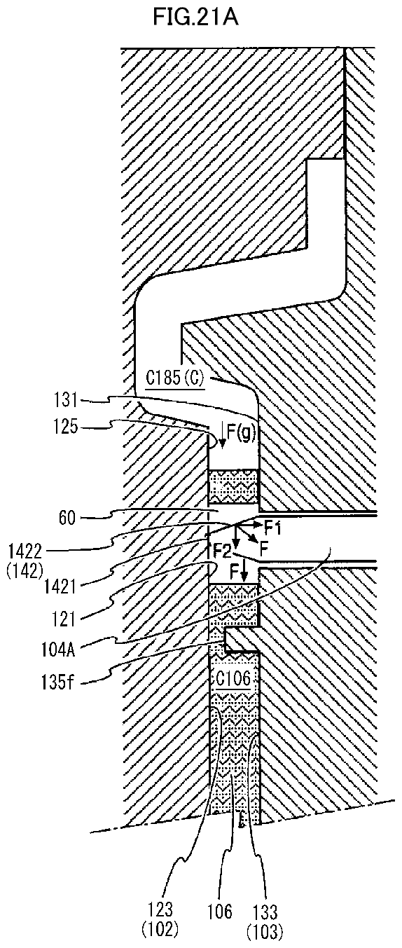

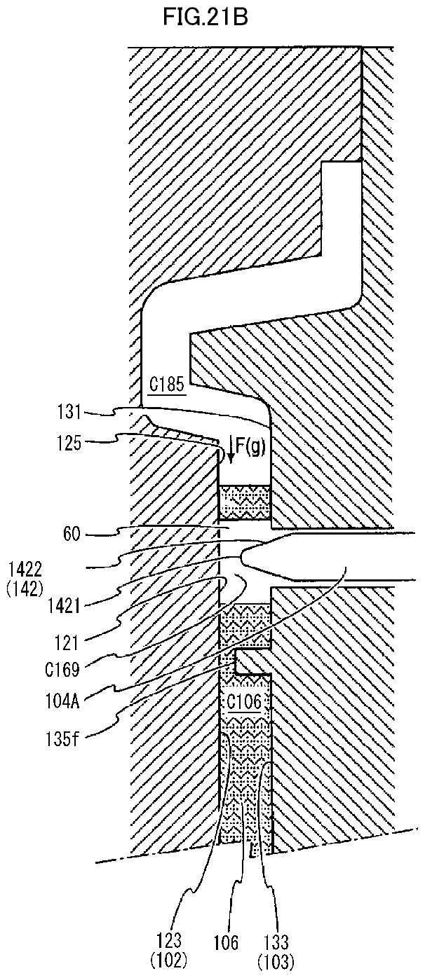

Thus, after the porous sheet 106 is deformed into a predetermined shape by the mold 101, the resin raw material g enters the frame portion cavity portion C185 and the crosspiece portion cavity portion C187. Due to the flow of the resin material g into the cavity C, the leading end 1421 of the movable pin 104A retreats from a state in which the leading end 1421 contacts the cavity face 121 of the fixed mold 102 in FIG. 21A to the state in FIG. 21B. Resin raw material g enters the through-hole 160 and the outer peripheral portion of the porous sheet 106 including the empty space C169 formed after the movable pin 104A has been retracted from the cavity face 121, and the resin molded portion 108 including the resin entry curing portion 184 is molded. The mold 101 is not limited to pressing and deforming the porous sheet 106, and molding the frame portion 185 and the crosspiece portions 187. The resin molded portion 108 and the porous sheet 106 are integral with each other by the resin entry curing portion 184 formed by the resin raw material g entering the outer peripheral portion of the porous sheet 106 corresponding to the peripheral portion of the frame portion opening 1850, and more specifically, by the resin entry curing portion formed at the base portion of the crosspiece portion 187.

The composite member P is manufactured using the mold 101, for example, in the following manner. First, in the mold open state, the flange 1411 that has received the elastic bias of the spring 152A moves toward the cavity face 131 side of the movable mold 103. The flange 1411 contacts and stops the enlarged diameter inner wall 1513 extending from the small hole portion 1511 to the large hole portion 1512, and the leading end portion 142 of the movable pin 104A projects out from the cavity face 131 (FIG. 19B). A movable pin 104A having a positioning function projects out from a cavity face 131 forming a rear face side of the composite member P, in accordance with each of the through-holes 160 provided in the porous sheet 106 in FIG. 17A.

In such a state, the porous sheet 106 that has been softened by being appropriately heated to a predetermined temperature is inserted into the movable pin 104A, and the porous sheet 106 is set in the movable mold 103. The porous sheet 106 is cut into sizes corresponding to the panel portions 107 in advance. The through-holes 160 are provided at positions where the movable pins 104A contact when the porous sheet 106 is set in the cavity C. Here, three through-holes 160 are provided above and three at the lower portion of the porous sheet 106, respectively, with spacing therebetween. When each of the through-holes 160 is passed through the movable pin 104A and the porous sheet 106 is contacted to the movable mold 103, the porous sheet 106 is autonomously positioned and held in the cavity face 131. Note that as an injection molding machine, a horizontal mold type molding machine in which a movable mold moves in a horizontal direction with respect to a fixed mold is widely used. In contrast thereto, in cases in which the movable mold is a vertical type injection molding machine that moves vertically with respect to the fixed mold, it is sufficient to place the porous sheet on the upper face (cavity face) of the lower mold, such that setting of the porous sheet is easy. However, in a horizontal type injection molding machine as in the present exemplary embodiment, as illustrated in FIG. 18, the cavity surfaces 121, 131 of the mold 101 are vertical planes, and so setting of the porous sheet 106 is difficult. However, according to the present exemplary embodiment, in cases of a horizontal type injection molding machine, the porous sheet 106 can be easily set, even in cases in which the cavity surfaces 121, 131 are vertical planes, only by inserting the movable pin 104A through the through-hole 160 of the porous sheet 106.

Next, as illustrated in FIGS. 20 and 21A, by clamping, the movable pin 104A abuts the cavity face 121 of the fixed mold 102 forming the design face of the composite member P and is retracted against the elastic bias of the spring 152A, and the porous sheet 106 is deformed into a desired shape. As clamping progresses, the movable pin 104A projecting out of the cavity face 131 of the movable mold 103 contacts the cavity face 121 of the fixed mold 102. In a state in which the leading end 1421 contacts the cavity face 121, the spring 152A is compressed by a clamping pressure that overcomes the elastic bias of the spring 152A, and the leading end 1421 of the movable pin 104A retracts from the point in FIG. 19A to the point in FIG. 20 at the time of completion of clamping. The movable pin 104A provided so as to be capable of moving inside the through-hole 130 provided in the movable mold 103 stops in the state illustrated in FIG. 20 in which the leading end 1421 has contacted the cavity face 121 of the fixed mold 102. By clamping, the porous sheet 106 is sandwiched and compressed between the cavity face 131 of the movable mold 103 and the cavity face 121 of the fixed mold 102. Initially, the porous sheet 106 with the thickness t1 is compressed in the thickness direction, and inside the cavity C, the whole porous sheet 106 is deformed into a three-dimensional shape with a thickness t2 illustrated in FIG. 17B, and is deformed into a shape that maintains a porous structure for sound absorption.

The present disclosure uses the porous sheet 106 of FIG. 17A having a sound absorption function, compresses the porous sheet 106, and transforms the porous sheet 106 into a three-dimensional shape including the upper stage face 178 and the lower stage face 179 sandwiching the oblique face 177, as illustrated in FIG. 17B, for example, but also retains the sound absorption function after deformation. However, in cases in which the porous sheet 106 is compressed from the thickness t1 to the thickness t2 to have increased strength, it is difficult to maintain the deformed shape in a three-dimensional shape in which the sound absorption porous structure is maintained. Thus, in order to compensate for the strength of the porous sheet 106, as illustrated in FIG. 23, a frame portion 185 and a crosspiece portion 187 are provided.

A disadvantage in which holes due to the movable pin 104A appear in the product design face, if left as it is, is resolved by employing, at the leading end portion 142, a movable pin 104A including an oblique face portion 142a that is inclined with respect to the cavity face 121 of the fixed mold 102, serving as a facing portion thereof. Such a problem is resolved due to the movable pin 104A including the leading end portion 142 of the oblique face portion 142a, making good use of the injection pressure of the resin raw material g, and the movable pin 104A retracting.

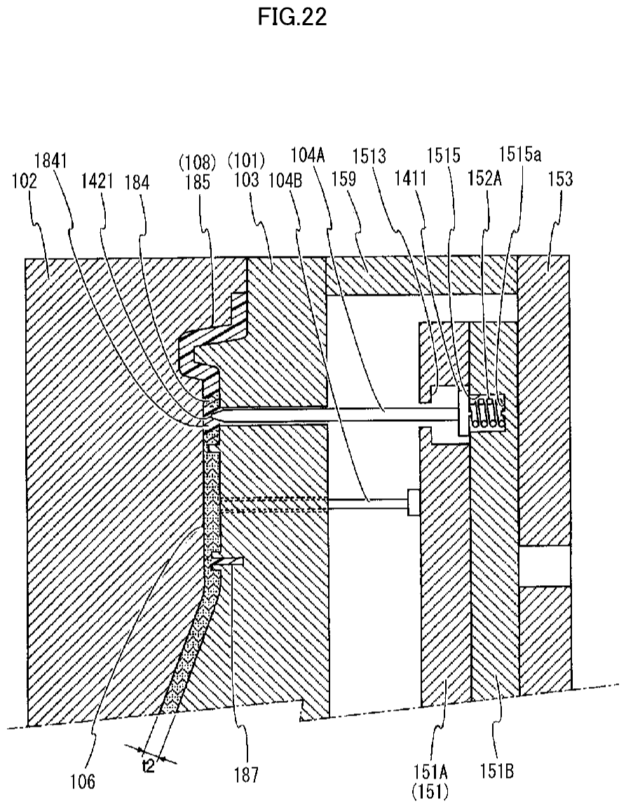

More specifically, as illustrated in FIGS. 21A to 22, after clamping, the resin raw material g is injected, the movable pin 104A is retracted from the cavity face 121 of the fixed mold 102 by the flow of the resin raw material g, and the resin molded portion 108 is molded by the resin raw material g entering the through-hole 160 including the empty space C169 formed by this retraction. When the resin material g flowing in the vicinity of the leading end portion 142 of the movable pin 104A acts on the oblique face portion 142a, a force F in the perpendicular direction acts on the oblique face portion 142a. The force F in the perpendicular direction generates a component force F 1 in the horizontal direction by the oblique face portion 142 a. The component force F1 retracts the movable pin 104A. When clamping, the resin material g is injected into the cavity C from a nozzle of the injection molding machine through a runner and a gate, not illustrated in the drawings. As the resin raw material g, for example, a polypropylene resin raw material can be used. As illustrated in FIG. 21A, a force F of injection pressure is applied to the movable pin 104A. A conical tapered face 1422 serving as an oblique face portion 142a is provided at the leading end portion 142 of the movable pin 104A, such that the tapered face 1422 is in a state floating up and separated from the cavity face 121, except for the leading end 1421, inside the cavity. A tapered face 1422 in the shape of a conical surface with point symmetry is evenly spread out radially outward from the leading end portion 142 with respect to the axis center of the movable pin 104A made of a round bar processed product, such that the movable pin 104A is pushed toward the pin shaft rear side with a component force F1 and is retracted. The leading end 1421 of the movable pin 104A pushed by the force component F1 retracts to a position separated from the cavity face 121. The component force F1 received by the tapered face 1422 and pushed toward the base end portion 141 and the elastic restoring force of the spring 152A are in equilibrium, and the movable pin 104A stops at the position illustrated in FIG. 21B. An empty space C169 is formed between the cavity face 121 of the fixed mold 102 and the leading end 1421. Note that it is preferable that the tapered face 1422 provided to the movable pin 104A be formed in a shape that is pointed at an angle θ from the leading end 1421 of the movable pin 104A, as illustrated in FIG. 19B. It is more preferable that the angle θ be set at an obtuse angle than an acute angle in order to increase the force component F1.

In a state in which the movable pin 104A is separated from the cavity face 121 of the fixed mold 102 and is retracted, injection of the resin material g into the cavity C proceeds. The resin raw material g enters the frame portion cavity portion C185 and the crosspiece portion cavity portion C187. In addition thereto, the resin raw material g enters the outer peripheral portion of the porous sheet 106 in which the porous structure is maintained, and the through-holes 160 including the empty space C169. And the resin molded portion 108 including the resin entry curing portion 184 is molded. Resin material g enters the through-hole 160, and a through-hole filling portion 1841 is formed.

The resin raw material g attempts to enter deeper into the inside of the porous sheet 106 maintained in a porous structure from the outer peripheral portion of the porous sheet 106, but is blocked by the biting protrusions 135f formed in the frame portion. The resin raw material g attempts to enter deep inside the porous sheet 106 from the root portion of the crosspiece cavity portion C187, but is blocked by the biting protrusion 137f in crosspiece formation. Namely, in the clamping, the projections 135f, 137f bite into the porous sheet 106 by an amount that projects out further toward the porous sheet 106 side than the cavity face 131 in the vicinity thereof, further compressing and densifying the porous structure of the porous sheet 106, thereby making entry of the resin material g difficult. When the resin material g enters deep inside the porous sheet 106, the sound absorption performance of the porous sheet 106 is deteriorated, but the projections 135f, 137f prevent such resin material g from entering.

Since the biting protrusion 135f for frame portion formation is formed slightly smaller than the outer circumference of the porous sheet 106, the resin entry curing portion 184 is molded only in the mesh structure in the region of the outer circumference portion of the porous sheet 106. Thus, a joint area P78 in which the resin entry curing portion 184 and the outer peripheral portion of the porous sheet 106 are integrally formed is formed.

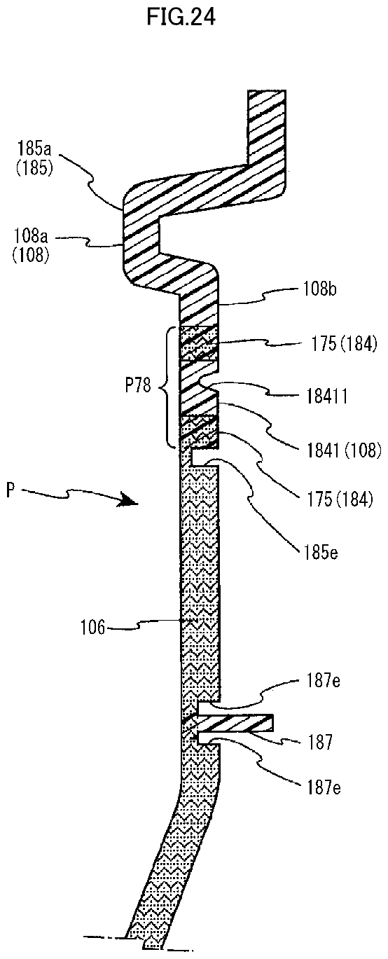

In this manner, the resin material g enters the outer peripheral portions of the porous sheet 106 and the through-holes 160 including the empty space C169. Thus, the composite member P, in which the resin molded portion 108 including the resin entry curing portion 184 with the through-hole filling portion 1841 and the porous sheet 106 are integrally formed, is molded. The porous sheet 106 is deformed by clamping, the resin raw material g is injected into the cavity C in a state in which the deformed porous sheet 106 is put in the cavity C, and a resin molded portion 108 including a frame portion 185, a crosspiece portion 187, and a resin entry curing portion 184 is formed. As illustrated in FIG. 24, the recessed mark 18411 of the movable pin 104A remains in the through-hole filling portion 1841 in which the through-hole 160 is filled, but the recessed mark 18411 is formed not on the design face 108a of the resin molded portion 108, but on the rear face 108b, and so there is no problem in the aesthetics of the product.

After molding the resin molded portion 108, the resin molded portion 108 is demolded from the mold 101, thereby obtaining a composite member P, in which the porous sheet 106 and the resin molded portion 108 that have a porous structure are integrally formed.

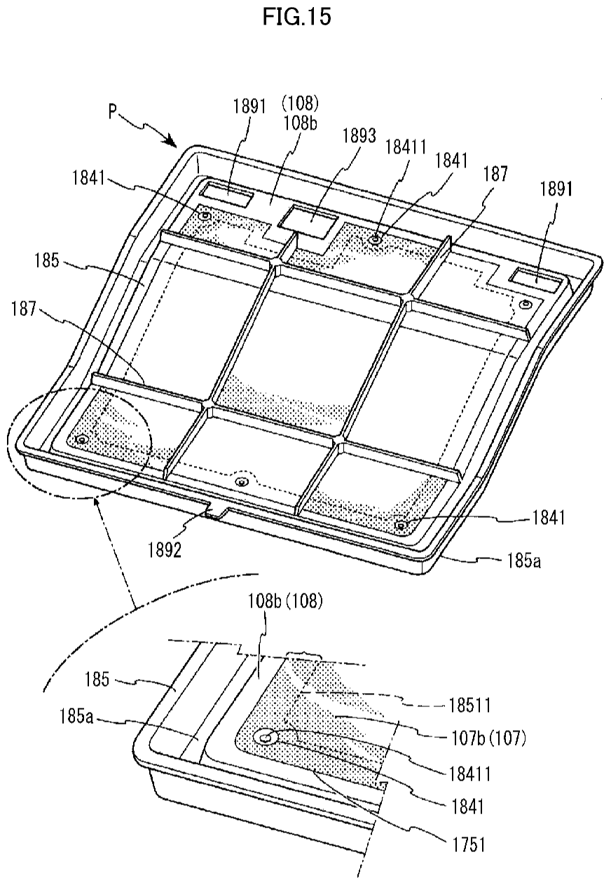

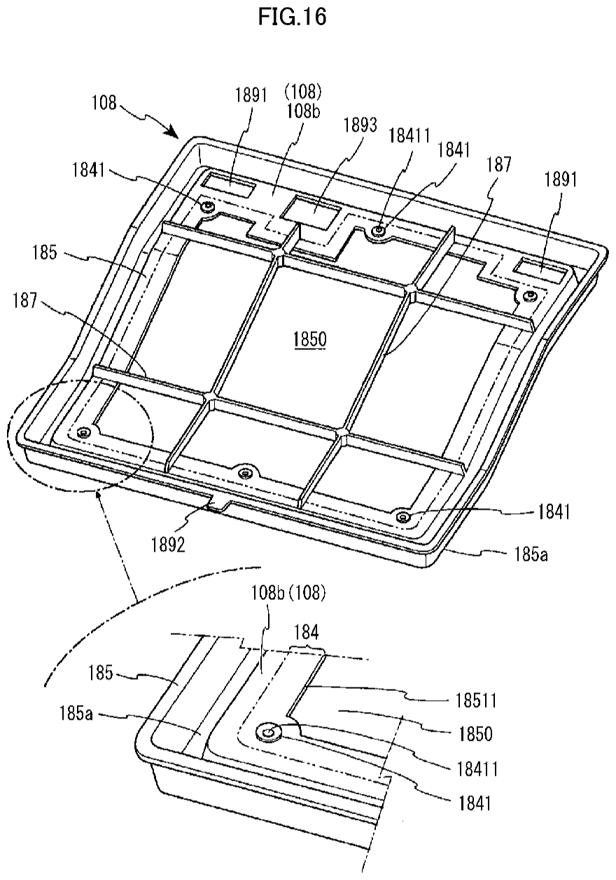

As illustrated in FIG. 23, when the ejector rod 154 is advanced, the composite member P projects out due to the projecting pin 104B and the movable pin 104A, and the movable pin 104A is further advanced under the biasing force of the spring 152A, such that the composite member P is demolded from the mold 101. Together with the projecting pin 104B, whose leading end coincides with the cavity face 131, the movable pin 104A projects out toward the cavity C side, and the composite member P is demolded. Reference numeral 185a denotes a frame reinforcing portion, reference numerals 185e and 187e denote seal marks (not illustrated in FIGS. 15 and 16) left by the biting projections 135f and 137f, reference numeral 1891 indicates an attachment port to a mating member, 1892 indicates an attachment piece to a mating member, and 1893 indicates an opening for a separate component.

### Effect

The manufacturing method of the composite member P configured in this manner, and the mold 101 used in the same, make up the composite member P, including the light porous sheet 106, and is therefore light in weight. When the porous sheet 106 is a nonwoven fabric, the porous sheet 106 can be easily deformed in a state in which a porous structure is maintained, and can be easily manufactured into a composite member P including sound absorption characteristics.

Since the tapered face 1422 that is inclined with respect to the cavity face 121 of the fixed mold 102 is formed at the leading end portion 142 of the movable pin 104A, the movable pin 104A is retracted from the cavity face 121 due to the flow of the synthetic resin material g into the cavity C after clamping. As in the present exemplary embodiment, when the conical tapered face 1422 is provided at the leading end portion 142, the movable pin 104A is smoothly retracted. The resin material g enters the empty space C169 after the retraction. Since the porous sheet 106 has a porous structure, the resin material g enters the through-hole 160 including the empty space C169 through the outer peripheral portion thereof, and the through-hole filling portion 1841 is molded. A resin entry curing portion 184 including a through-hole filling portion 1841 is formed, and a resin molded portion 108 that is integral with the porous sheet 106 is molded. Thus, no hole is formed through the movable pin 104A at the design face side of the composite member P. Unlike in Patent Document 1, no hole remains after the positioning pin has been pulled out, and the appearance is not negatively affected. There is also no degradation in sound absorption performance due to the holes.

Since the movable pin 104A is inserted through the through-hole 160 of the porous sheet 106 and the porous sheet 106 is positioned and set in the one mold 103, it is unnecessary to use a porous sheet 106 of an unnecessary size, unlike in Patent Document 2. This eliminates the need for a post-process of cutting an extra length portion, unlike in Patent Document 2.

The movable pin 104A of the present exemplary embodiment has two functions, namely, a function of positioning the porous sheet 106 in the cavity C, and a function of serving as a projecting pin for removing the formed composite member P from the cavity C. When the spring 152A is employed as the elastic body 152, operation of projecting the composite member P out of the movable mold 103 or operation of retracting the movable pin 104A from the cavity C can be realized at low cost.

Since the movable pin 104A including the tapered leading end portion 142 is employed, the movable pin 104A can be efficiently retracted from the cavity face 121 of the fixed mold 102 using the flow of the resin material g into the cavity C. Thus, there is no need to incorporate a new mechanism into the mold 101 for retracting the movable pin 104A from the cavity face 121. In the present exemplary embodiment, the through-hole filling portion 1841 of resin is molded in the through-hole 160, and no hole remains in the product, such that neither the appearance nor the sound absorption effect is deteriorated. Post-processing to close the through-hole of the through-hole 160 is also unnecessary. Note that the recessed mark 8511 of the movable pin 104A remains on a face that is not a design face, and so the appearance of the product is not a problem.

More specifically, as the porous sheet 106, it is preferable to adopt a nonwoven fabric in which a sheath portion of a fiber is made of a low melting point material, and a core portion is made of a high melting point material. When clamped by the mold after the nonwoven fabric is heated, the porous sheet 106 is deformed using a fiber material with a high melting point, and the shape of the porous sheet 106 can be easily maintained due to the low melting point fiber materials bonding together.

Note that the present disclosure is not limited to those illustrated in the above exemplary embodiments, and various modifications can be made within the scope of the present disclosure, depending on the purpose or application. Shapes, sizes, numbers, materials, and the like of the mold 101, the fixed mold 102, the movable mold 103, the movable pin 104A, the elastic body 152, the porous sheet 106, the resin molded portion 108, and the like can be appropriately selected according to applications.

The composite member P of the present exemplary embodiment is applicable to an undercover of an instrument panel, an engine undercover, or the like. Depending on the shape of the composite member P, the shape of the porous sheet 106 need not be formed into a three-dimensional shape as long as it is compressed between the cavity face 131 of the movable mold 103 and the cavity face 121 of the fixed mold 102 by clamping.

In the present exemplary embodiment, the movable pin 104 A including the tapered leading end portion 142 is employed; however, the present disclosure is not limited thereto. It is sufficient that the leading end portion 142 of the movable pin 104A has an oblique face portion 142a that is inclined with respect to the cavity face of the another mold corresponding to the leading end portion 142 of the movable pin 104A.

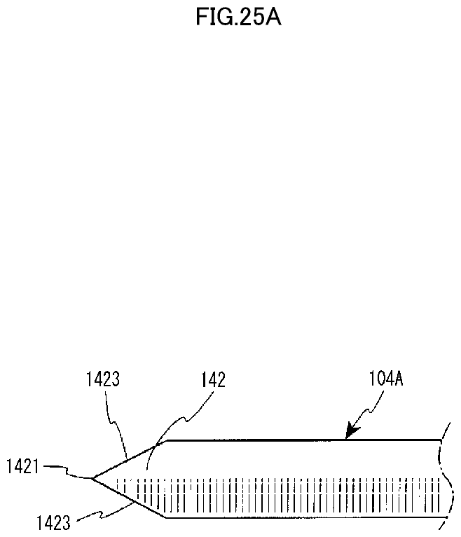

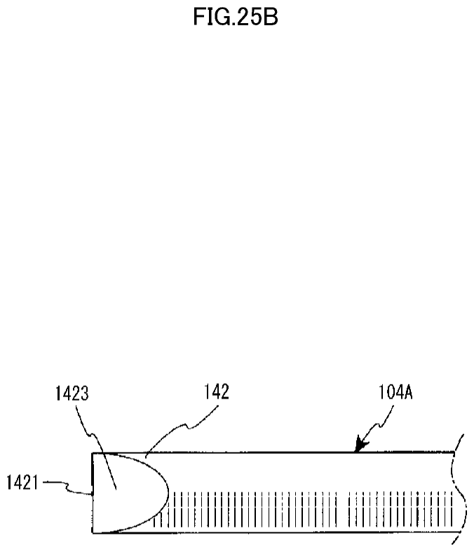

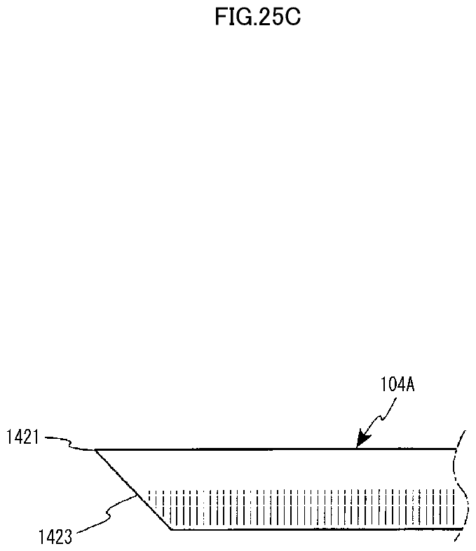

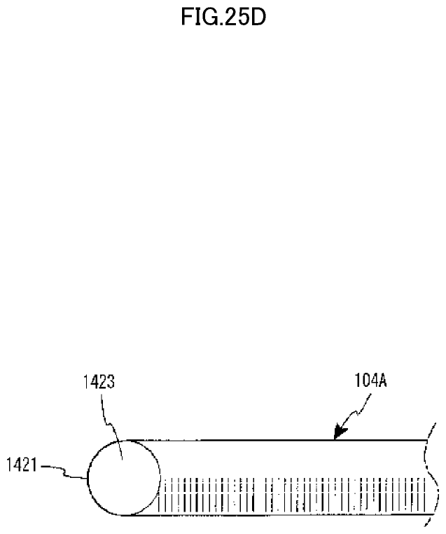

As illustrated in FIGS. 25A and 25B, the leading end portion of the movable pin 104A may be in the shape of a minus driver, in addition to the above-described conical tapered face 1422. The illustrated leading end portion 142 includes an oblique face portion 1423 formed by leaving a flat leading end 1421 at the center from a round bar member, and cutting both sides of the leading end 1421 obliquely. Alternatively, the leading end portion 142 of the movable pin 104A may be as illustrated in FIGS. 25C and 25D, and the oblique face portion of the leading end portion 142 may be a planar oblique face portion 1423 formed by obliquely cutting a round bar member. In either case, when the movable pin 104A contacts the cavity face 121 of the fixed mold 102, the oblique face portion is in a state separated from the cavity face 121, such that the component force F1 by the resin material g can be acted on, and the movable pin 104A can be retracted toward the movable mold 103 side from the cavity face 121 of the fixed mold 102.

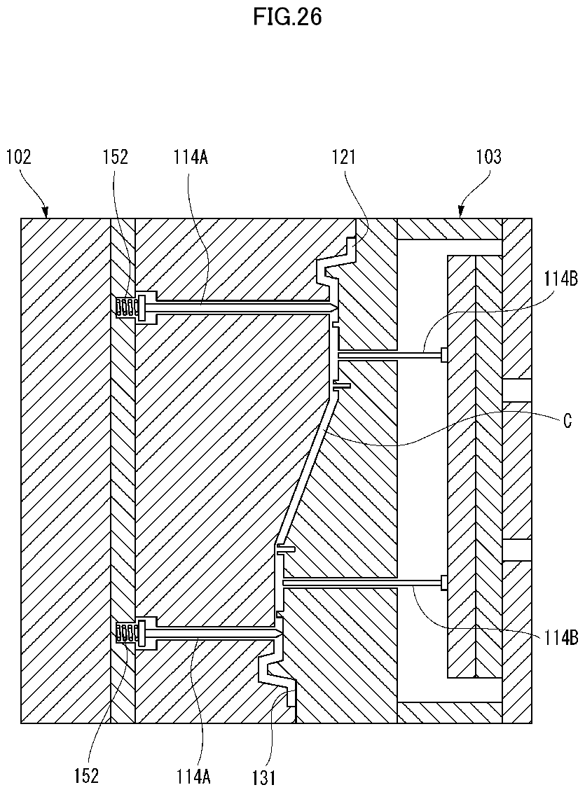

In the above exemplary embodiments, there has been explained an example in which both the movable pin 104A and the projecting pin 104B are provided to the movable mold 103, however, as illustrated in FIG. 26, the movable pin 114A and the projecting pin 114B may be provided to mutually different molds. In the illustrated example, the movable pin 114A is provided to the fixed mold 102, and the projecting pin 114B is provided to the movable mold 103. Such a configuration enables a step of positioning the porous sheet 106 to the fixed mold 102 using the movable pin 114A, concurrently with a step of removing the composite member P attached to the movable mold 103 side using the projecting pin 114B after the resin raw material g has been cured. Namely, the step of positioning the porous sheet 106 and the step of demolding the composite member P can be performed simultaneously, thereby enabling manufacturing time to be reduced. Note that different from the illustrated example, the movable pin 114A may be provided to a movable mold, and the projecting pin 114B may be provided to a fixed mold.

The present application is based on Japanese Patent Application No. 2019-080574, filed Apr. 20, 2019, and Japanese Patent Application No. 2019-138023, filed Jul. 26, 2019, the contents of which are hereby incorporated by reference.

### INDUSTRIAL APPLICABILITY

The present disclosure provides a method of manufacturing a composite member in which no hole is provided in the design face, and a mold used in the method.

1. A method of manufacturing a composite member, in which a porous plate member and a resin molded portion are integrally formed using a mold, the mold comprising:
one mold;
another mold facing the one mold and forming a cavity with the one mold when the one mold and the another mold are clamped together; and
a plurality of movable pins including a base end portion that is in contact with the one mold via an elastic body,
the movable pin being capable of retracting a leading end portion thereof from a state in which the leading end portion projects out from a cavity face of the one mold toward the another mold, to a position that is retracted from a cavity face of the another mold at a time of clamping, by deforming the elastic body, and
the leading end portion having an oblique face portion that is inclined with respect to the cavity face of the another mold, toward which the oblique face portion faces,
the method comprising:
positioning the porous plate member in the one mold using the movable pin in a state in which the leading end portion of the movable pin projects out toward the another mold;
clamping the one mold and the another mold together to press the porous plate member, and pressing a leading end portion of the movable pin by the another mold to retract the movable pin against an elastic restoring force of the elastic body; and
forming the composite member, in which the porous plate member and the resin molded portion are integrally formed, by injecting a synthetic resin raw material into the cavity such that a flow of the synthetic resin raw material is applied to the leading end portion of the movable pin, the movable pin is further retracted against an elastic restoring force of the elastic body, and the synthetic resin raw material is cured in a state in which the synthetic resin raw material has entered a space in which the leading end portion of the movable pin has been retracted, thereby forming a resin molded portion.

2. The method of manufacturing a composite member of claim 1, wherein the porous plate member is positioned in the one mold by supporting an outer peripheral side face of the porous plate member with the movable pin.

3. The method of manufacturing a composite member of claim 1, wherein through-holes are provided in the porous plate member, and the porous plate member is positioned in the one mold by inserting the movable pin through the through-hole.

4. The method of manufacturing a composite member of claim 1, wherein the porous plate member is pressed in a state in which a sound absorption porous structure of the porous plate member is maintained.

5. The method of manufacturing a composite member of claim 1, wherein the porous plate member is a foam or a nonwoven fabric.

6. The method of manufacturing a composite member of claim 1, wherein:
the composite member comprises a frame portion and a crosspiece portion provided so as to cross through the frame portion, and
the cavity comprises:
a porous plate member cavity portion in which the porous plate member is disposed;
a frame portion cavity portion that surrounds the porous plate member cavity portion and forms the frame portion; and
a crosspiece cavity portion that forms the crosspiece.

7. The method of manufacturing a composite member of claim 1, wherein the elastic body is a spring.

8. A mold for manufacturing a composite member, in which a porous plate member and a resin molded portion are integrally formed, comprising:
one mold;
another mold facing the one mold and forming a cavity with the one mold when the one mold and the another mold are clamped together; and
a plurality of movable pins including a base end portion that is in contact with the one mold via an elastic body,
the movable pin being capable of retracting a leading end portion thereof from a state in which the leading end portion projects out from a cavity face of the one mold toward the another mold to a position retracted from a cavity face of the another mold at a time of clamping, by deforming the elastic body,
the leading end portion of the movable pin being formed with an oblique face portion inclined with respect to a cavity face of the another mold, toward which the oblique face portion faces, and
an elasticity coefficient of the elastic body being adjusted such that the leading end portion of the movable pin is retracted from a cavity face of the another mold due to a flow of a synthetic resin material being injected into the cavity.

9. The mold of claim 8, wherein the elastic body is a spring.

10. The mold of claim 8, wherein the one mold and the another mold are clamped together while moving relatively horizontally.

11. The mold of claim 10, wherein the plurality of movable pins are provided at positions that support a lower edge of the porous plate member.
